(19) United States
(12) Patent Application Publication
(10) Pub. No.: US 2021/0191779 A1
(43) Pub. Date: Jun. 24, 2021

(54) OPERATING SYSTEM LEVEL DISTRIBUTED AMBIENT COMPUTING

(71) Applicant: Google LLC, Mountain View, CA (US)

(72) Inventors: Marco Zamarato, San Francisco, CA (US); Kara Gates, Mountain View, CA (US); Sameer Bansal, San Francisco, CA (US); Chrisoula Kapelonis, Mountain View, CA (US); Evan Malahy, Sunnyvale, CA (US)

(21) Appl. No.: 16/727,349

(22) Filed: Dec. 26, 2019

Related U.S. Application Data
(60) Provisional application No. 62/949,929, filed on Dec. 18, 2019.

(51) Int. Cl. G06F 9/50; G06F 9/52

(52) U.S. Cl. CPC G06F 9/5027; G06F 2209/506; G06F 9/52

(57) ABSTRACT

Systems and methods are described distributed ambient computing. A method may include detecting, by a computing device associated with a user environment, a plurality of additional devices associated with the user environment, determining, for the plurality of additional devices, a plurality of capabilities associated with the plurality of additional devices, and configuring, by the computing device, the plurality of additional devices as a distributed computing system. The method may further include receiving, at the computing device, a request to execute a task, selecting at least one of the plurality of additional devices determined to be capable of executing the task, and triggering the selected device to execute the task.

### CROSS-REFERENCE TO RELATED APPLICATION

This application claims priority to U.S. Provisional Patent Application No. 62/949,929, filed on Dec. 18, 2019, entitled “OPERATING SYSTEM LEVEL DISTRIBUTED AMBIENT COMPUTING”, which is incorporated by reference herein in its entirety.

### BACKGROUND

Traditional electronic devices may execute software using an operating system. For example, a mobile phone device may be configured to operate hardware and onboard software with a dedicated operating system that communicates amongst hardware components on the device. Such an operating system is typically intended to control and manage software and hardware functions on the devices. Other electronic devices may operate in the same manner executing software for each respective separate device using the respective onboard device operating system.

### SUMMARY

The systems and methods described herein may function to generate distributed computing environments (e.g., systems) that utilize computing devices and/or other electronic devices as interchangeable modules of a distributed ambient computing system that can encompass and/or access available devices within a defined location, building, complex, etc. The distributed ambient computing system may be an operating system that is deployed over multiple devices to have a global view of such devices. The distributed ambient computing system may use the operating system to distribute computing tasks over a number of devices. For example, the various electronic devices owned and/or accessed by a user throughout a day are generally not configurable to ambiently function together because such devices may not have a global understanding of the other respective devices surrounding each of the various electronic devices.

The systems and methods described herein can be used to determine the global understanding of devices surrounding a defined location and in order to configure the various electronic devices as a distributed ambient computing system that may function to orchestrate and distribute tasks amongst one or more of the various electronic devices. Each of the devices may be defined and/or associated with sensors (e.g., for generating inputs/outputs) and capabilities to be utilized to complete the tasks. The systems and methods described herein may provide improved resource management among electronic devices within a defined location such as a household or office. A user may be able to leverage the use of sensors and capabilities among the plurality of the devices in their household or office, allowing tasks to be performed that would previously not have been able to be performed by a single device alone in the household or office, or that would have been difficult to perform. The user may therefore be able to instruct a technical task to be completed that previously may not have been able to be completed by a single computing device alone. Furthermore, the user may be able to do this without having to add one or more new computing devices to the defined location to perform the task (e.g., purchasing an additional computing device). The systems and methods described herein may allow for a reduction in the redundancy of sensors and capabilities in a defined location, and an improvement in the utilization of said sensors and capabilities. A user may be able to have a larger variety of tasks performed, but using fewer computing devices in the defined location, which can have power consumption benefits and environmental benefits.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In a first general aspect, a computer-implemented method is described. The method may include detecting, by a computing device, a plurality of additional devices associated with the user environment, determining, for the plurality of additional devices, a plurality of capabilities associated with the plurality of additional devices, and configuring, by the computing device, the plurality of additional devices as a distributed computing system. The plurality of additional devices may correspond to at least one of the plurality of capabilities and a device location within the user environment. The method may further include receiving, at the computing device, a request to execute a task, determining, by the computing device, which of the plurality of additional devices are capable of executing the task, and selecting at least one of the plurality of additional devices determined to be capable of executing the task. The selecting may be based at least in part on a determined proximity of the plurality of devices to the computing device or to a user associated with the request to execute the task, a determined operating system executing on a respective device in the plurality of devices, and determined sensor-based capabilities available on a respective device in the plurality of devices. The method may also include triggering, by the computing device, the selected device to execute the task.

Implementations may include any or all of the following aspects. In some implementations, selecting of the at least one of the plurality of additional devices is further based on detected information associated with the user environment, the user environment defined as a physical building containing the computing device and the plurality of additional devices. In some implementations, the detected information corresponds to a detected user activity level in the user environment, a detected audio request in the user environment, or detected visual imagery associated with the user environment. In some implementations, the method further includes selecting, by the computing device, a second device in the plurality of additional devices to generate output corresponding to the task. The selection of the second device may be based at least in part on determining that the selected at least one of the plurality of additional devices is unsuited to generate and communicate output corresponding to the task.

In some implementations, the method further includes selecting, by the computing device, a second device of the plurality of additional devices to generate output corresponding to the task. The selection of the second device may be based at least in part on determining that the location of the at least one of the plurality of additional devices is out of a predefined visual range or predefined audio range of a user associated with the request to execute the task. In some implementations, triggering the selected device to execute the task includes generating visual and audio output. The visual and audio output may be provided on another of the plurality of additional devices in response to determining a time of day outside of a predefined time period.

In some implementations, the method may further include triggering, by the computing device, the selected device to execute the task includes accessing, via an operating system associated with the computing device, at least one service in communication with the respective operating system executing on the selected at least one additional device. The service may be configured to dispatch the received task to at least one other device in the plurality of additional devices. In some implementations, selecting the at least one of the plurality of additional devices to execute the task includes determining a context for the user environment where the context may be based on detected information and stored information associated with one or more of the plurality of additional devices. In some implementations, the detected information includes calendar information. Implementations of the described techniques may include hardware, a method or process, and/or computer software on a computer-accessible medium.

in a second general aspect, a computer program product is described. The computer program product is tangibly embodied on a non-transitory computer-readable medium that includes instructions that, when executed, are configured to cause at least one processor to detect, by a computing device, a plurality of additional devices associated with the user environment, determine, for the plurality of additional devices, a plurality of capabilities associated with each of the respective additional devices, configure, by the computing device, the plurality of additional devices as a distributed computing system, the plurality of additional devices corresponding to at least one of the plurality of capabilities and a device location within the user environment, and receive, at the computing device, a request to execute a task. In response to determining that completing execution of the task indicates the use of two or more of the plurality of capabilities, the instructions may determine, within the distributed computing system, which of the plurality of additional devices is capable of executing the task, select at least two devices, in the plurality of additional devices, to share execution of the two or more capabilities to complete the task, the selecting of the at least two devices based at least in part on a determined proximity of the two devices to the computing device or to a user associated with the request to execute the task. The instructions may trigger, by the computing device, the selected at least two devices to execute the task.

Implementations may include any or all of the following aspects. In some implementations, the instructions may include selecting the at least two devices includes configuring the at least two devices to communicate to execute a plurality of separate portions of the task. In some implementations, selecting the at least two devices includes determining which of the plurality of devices include components configured to execute the two or more capabilities to complete the task and configuring the at least two devices to communicate to complete the task. In some implementations, at least one capability associated with at least one of the two devices extends a capability associated with the other of the at least two devices. In some implementations, the execution of the task is triggered in the absence of Internet connectivity for the devices in the distributed computing system. Implementations of the described techniques may include hardware, a method or process, and/or computer software on a computer-accessible medium.

In a third general aspect, a system is described that may include a display, memory, and at least one processor coupled to the memory, the at least one processor being configured to detect, by a computing device, a plurality of additional devices associated with a user environment, determine, for the plurality of additional devices, a plurality of capabilities associated with one or more of the plurality of additional devices, configure, by the computing device, the plurality of additional devices as a distributed computing system. The plurality of additional devices may be corresponding to at least one of the plurality of capabilities and a device location within the user environment. The processor may be further configured to receive, at the computing device, a request to execute a task, determine, by the computing device, which of the plurality of additional devices are capable of executing the task, select at least one of the plurality of additional devices determined to be capable of executing the task in which the selecting is based at least in part on a determined proximity of the plurality of devices to the computing device or to a user associated with the request to execute the task. The processor may be further configured to trigger, by the computing device, the selected device to execute the task.

Implementations may include any or all of the following aspects. In some implementations, configuring the plurality of additional devices as a distributed computing system includes enabling, for the plurality of additional devices, policies and user preferences associated with the user environment and the computing device and in response to detecting an unidentified device within the user environment, performing a security check on the unidentified device, and configuring the policies and user preferences on the unidentified device if the unidentified device passes the security check.

In some implementations, the processor is further configured to display a graphical control element on the display of the computing device to enable user selected control for the device selected to execute the task. In some implementations, the processor is further configured to select by the computing device, a second device of the plurality of additional devices to generate output corresponding to the task, the selection of the second device based at least in part on determining that the location of the at least one of the plurality of additional devices is out of a predefined visual range or predefined audio range of a user associated with the request to execute the task.

In some implementations, triggering the selected device to execute the task includes generating visual output, the visual output provided on the display of the computing device, in response to determining that the computing device is within a threshold distance to a user associated with the received request to execute the task. In some implementations, triggering, by the computing device, the selected device to execute the task includes accessing, via an operating system associated with the computing device, at least one service in communication with the selected at least one additional device, the service configured to dispatch the received task to at least one other device in the plurality of additional devices. Implementations of the described techniques may include hardware, a method or process, and/or computer software on a computer-accessible medium.

The details of one or more implementations are set forth in the accompanying drawings and the description below. Other features will be apparent from the description and drawings, and from the claims.

### BRIEF DESCRIPTION OF THE DRAWINGS

FIGS. 1A-1C are diagrams of example distributed ambient computing systems, in accordance with implementations described herein.

FIG. 2 is a block diagram illustrating an example distributed ambient computing system including multiple devices, in accordance with implementations described herein.

FIGS. 3A-3B are block diagrams illustrating example architectures for operating a distributed ambient computing system, in accordance with implementations described herein.

FIG. 4 is an example diagram illustrating a task request and execution of a task in a distributed ambient computing system, in accordance with implementations described herein.

FIGS. 5A-5C illustrate using two or more devices to execute a requested task, in accordance with implementations described herein.

FIGS. 6A-6C illustrate example distributed ambient computing systems for a household, in accordance with implementations described herein.

FIG. 7 is a diagram of an example of task execution carried out using ambient devices within a household, in accordance with implementations described herein.

FIG. 8 illustrates provisioning of resources amongst ambient devices within a household, in accordance with implementations described herein.

FIG. 9 illustrates providing modes within a household using ambient devices, in accordance with implementations described herein.

FIGS. 10A-10B illustrate an example of task handling using multiple ambient devices and a distributed storage log, in accordance with implementations described herein.

FIGS. 11A-11B illustrate examples of orchestrating activities and resources within a household using ambient devices, in accordance with implementations described herein.

FIG. 12 illustrates an example of orchestrating activities and sharing resources with devices associated with a household, in accordance with implementations described herein.

FIG. 13 is a diagram illustrating an ambient device sharing policies with other ambient devices associated with a household, in accordance with implementations described herein.

FIG. 14 is a diagram illustrating an ambient device recognition of at least two users, in accordance with implementations described herein.

FIGS. 15A-15B illustrate example ambient device configuration for a household, in accordance with implementations described herein.

FIG. 16 is a diagram illustrating another example of ambient device configuration for a household, in accordance with implementations described herein.

FIG. 17 illustrates another example of ambient device configuration for a household, in accordance with implementations described herein.

FIG. 18 is a diagram illustrating an example of an ambient device sharing policies and configuration details with other ambient devices associated with a household, in accordance with implementations described herein.

FIG. 19 is a diagram illustrating an example of configuring third party sensors for a household, in accordance with implementations described herein.

FIG. 20 is a flowchart of an example process of operating a distributed ambient computing system, in accordance with implementations described herein.

FIG. 21 is a flowchart of an example process of operating a distributed ambient computing system to share tasks amongst multiple devices, in accordance with implementations described herein.

FIG. 22 shows an example of a computer device and a mobile computer device that can be used to implement the techniques described herein.

The use of similar or identical reference numbers in the various drawings is intended to indicate the presence of a similar or identical element or feature.

### DETAILED DESCRIPTION

This document describes a platform for operating ambient computing devices (e.g., electronic devices) together as a distributed ambient computing system. The platform may function as a framework in which the operating systems of each of the electronic devices (e.g., computing devices, ambient devices, etc.) can be configured to execute and/or share execution of user-requested tasks amongst the ambient devices. In general, the systems and methods described herein can utilize such a platform to distribute tasks (e.g., processing tasks, user requested tasks, service oriented tasks, etc.) amongst devices (e.g., household devices) detected within and/or otherwise associated with a predefined location (e.g., a home). The tasks can be distributed based on device capabilities (e.g., sensors, processing capabilities, hardware, software), policies, user preferences, user permissions, requests, user location, device context, etc. Each device in the home may be defined as a set of inputs, a set of outputs, and a set of device capabilities in addition to a device location.

The systems and methods described herein may use a different paradigm than conventional systems to provide distributed ambient computing for task completion and presentation of content on one or more devices associated with the defined environment. For example, the systems and methods described herein may configure electronic devices to function together as a distributed operating system in which the operating system is executing on multiple devices that may allocate tasks to use device capabilities, rather than operate using conventional device interactions where each device typically operates using different hard coded operating systems that may not be compatible for communicating and sharing tasks amongst the plurality of devices. As a result, the systems and methods described herein may provide the advantages of increased communication efficiency between the electronic devices and a reduction in the amount of data transferred. Thus, the systems and methods employ a platform to transfer less data (or no data) from device to device, which may ensure secure data usage amongst the distributed ambient computing system.

The platform described herein may include or have access to an operating system (O/S) level distributed ambient computing system that accounts for user needs, home/household needs, service needs, and device capabilities. In some implementations, the O/S may operate distributed amongst the ambient devices in a particular location, building, household, home, complex, etc. The systems and methods described herein may utilize the platform to execute tasks on electronic devices defined as part of the distributed ambient computing system and located within (or associated with) a defined environment and may do so based on user-configured permissions.

In some implementations, the platform may enable distribution of such tasks amongst two or more of the electronic devices within the defined environment. For example, the systems and methods may operate using the platform to access an O/S level architecture associated with one or more devices in the defined environment to detect and communicate with each device in a predefined user environment. Other devices in the defined environment may not have the same O/S level architecture, and as such, the platform may instead utilize inputs and/or outputs associated with such devices in order to execute tasks in tandem with other devices in the defined environment that are configured to function with the O/S level architecture.

In operation, the platform executed by the systems and methods described herein can operate as an interface that functions to access a number of unique operating systems (on different devices) and provide UI content, data, audio content, etc., on electronic devices detectable within the defined environment. For example, the platform may allow each device in a predefined environment (e.g., a location representing a home, household, building, etc.) to be configured and defined as a set of inputs, a set of outputs and a set of device capabilities. Each device may include (or have access to) an operating system that may operate with the platform to execute and/or distribute tasks across any number of capable devices. For example, if a particular device is not configurable to carry out a user requested task, the systems and methods described herein can detect another device in the defined environment to share the task with a device that is capable of executing the user requested task. For example, a device, such as a new smart display with machine learning processing capabilities may be accessed by the platform in response to a task request in order to upgrade an older display without machine learning processing capabilities to take advantage of the machine learning capabilities of the newer smart display.

In some implementations, a user may utilize the platform and user permissions described herein to configure a number of environment policies and/or preferences for a home (e.g., household). The platform may access and share data from a distributed storage log (e.g., a ledger stored locally and available via a public or private network) for each device associated with the environment to obtain information regarding device states, past activities, etc. The distributed storage is configured to retain device data and/or user data, each of which remains in the environment to ensure that such data is not compromised. For example, a user can set policies and preferences targeted to a household of users associated with a home and the distributed storage may be used to share policies amongst devices. The policies may apply to an entire household, specific room or activities, specific devices, specific times, etc. For example, a user may configure a policy to disallow music louder than a threshold decibel level after a particular time of day.

In some implementations, the systems and methods described herein may be configured to share (and/or determine whether to share) such policies with any number of devices within the defined environment (e.g., user environment) according to user permissions and/or device settings. In some implementations, the systems and methods described herein may be configured to set other device-specific policies, which can be shared with one or more other devices within the distributed ambient computing system without having to wait for a user to manually update such devices with the particular policies. Such example policies may include, but are not limited to polices for camera use (or other sensor use) for camera-capable (or sensor-capable) devices near or within particular spaces, policies for device access limits for particular users and/or times, and policies regarding do not disturb configurations for particular users, devices, and/or times. In some implementations, a portion, or in some examples all, devices within the distributed ambient computing system may follow the policies as configured by a user of the computing system.

Similarly, when new devices are added (or moved) to the home (i.e., associated with, or defined by, the distributed ambient computing system), the new devices may inherit the existing configurations for the home and/or room policies. For example, the platform may utilize an underlying device O/S to trigger notification for each particular device and each device may determine and/or interpret what the policy is intended to configure. Each device may then configure the received policy according to the interpretation of the received notification. For example, a device may determine how to configure a do not disturb policy based on which sensors and/or corresponding capabilities are available within itself. The device can then turn off the disturbing sensors and/or capabilities according to the policy.

In general, one technical problem that may arise when attempting to share task execution amongst devices may include device incompatibilities at the software, hardware, and/or firmware level. For example, the various electronic devices owned and/or accessed by a user throughout a day are generally not configurable to ambiently function together as a single computer. Such devices typically operate using different hard coded operating systems that may not be compatible amongst the devices. This may present a technical challenge in that it may be complicated, time consuming, or improbable for a user to synchronize home devices, in general, and also difficult to synchronize communication and/or policies when new devices are added and/or brought into and out of the home.

The systems and methods described herein provide a technical solution to the technical problem by enabling communication amongst electronic devices and to allow for distribution and sharing of user requested tasks in order to provide convenient execution of tasks requested by users in a household. For example, an underlying O/S executing on one or more of the detected devices associated with a defined environment (e.g., a location area), for example, can be configured to dynamically distribute computing tasks to a capable device within the location area. In some implementations, the operating system can access a dedicated service tasked with detecting, identifying, and ranking devices available in the location (e.g., home, household, building, etc.) and can make decisions to dispatch and orchestrate tasks across detected and/or otherwise available devices. Such decisions may take into account an O/S running on the devices to determine whether particular devices can control other devices or simply pass information to the other devices.

The technical solutions described herein may provide a technical effect of improved task management, improved task assessment, and/or improved decision handling amongst household devices. The systems and methods may also provide a way to select amongst which devices execute and/or share execution of received tasks using a location-implemented distributed storage that is not owned or operated by a service provider nor a manufacturer of the devices at the location.

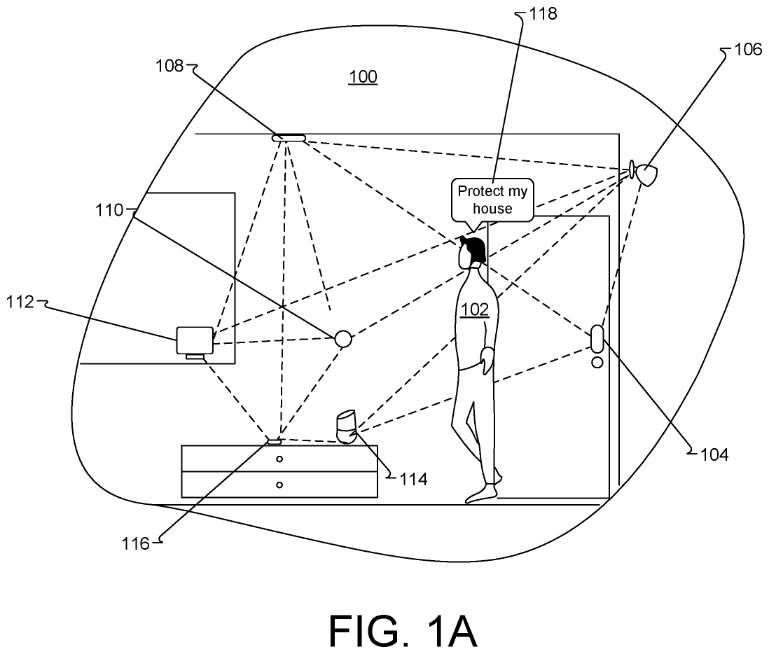

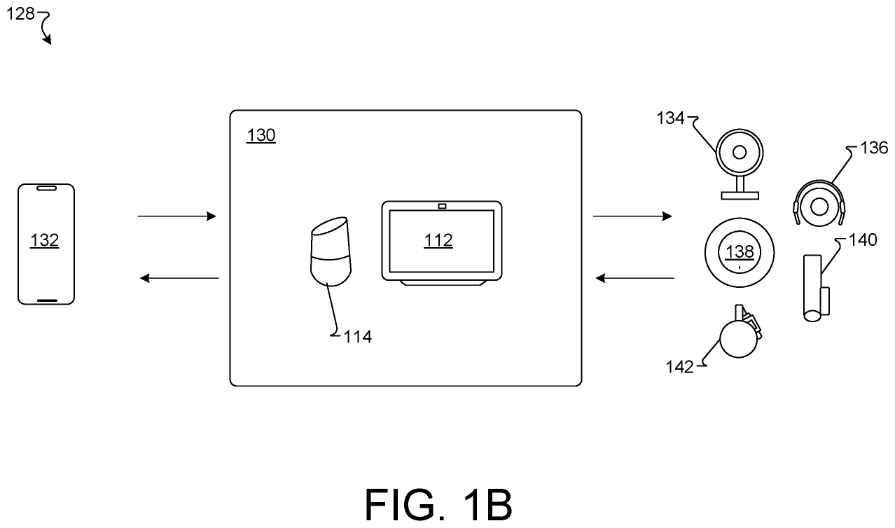

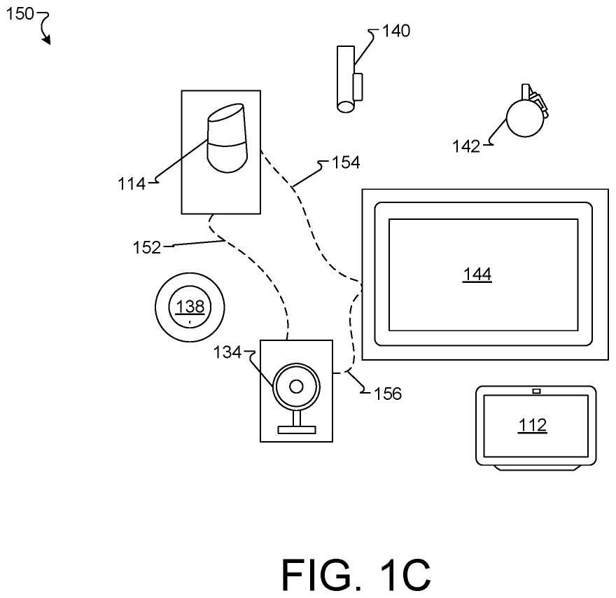

FIG. 1A is a block diagram of an example distributed ambient computing system 100, in accordance with implementations described herein. In the example system 100, a user 102 may be in a home (e.g., household location) that includes (or is associated with) any number of devices within the home. The home may represent a user environment (e.g., location/location area) which may be configured as a distributed ambient computing system 100 for the devices associated with the home. The user environment may be defined by a user to include the home and particular areas surrounding the home. In some implementations, devices within the home can be configured to set the boundary of the user environment according to user request, threshold settings, and/or distance from device policies implemented by a manufacturer and configurable by the user.

In general, the example distributed ambient computing system 100 may provide users with value from devices in the household/home because system 100 may utilize each device as a collection of capabilities that may be used together to accomplish a goal (e.g., task).

As shown in FIG. 1A, the devices include a number of ambient devices including a door lock device 104, a security device 106, a smoke detector device 108, an occupancy sensor device 110 (e.g., including a thermostat), an environment hub device 112, an assistant device 114, and an audio/microphone device 116. Each of the devices are shown connected by a dotted line representing the network of ambient devices within the distributed ambient computing system 100. The connection between devices may be wireless, as described in detail below. In some implementations, devices may share data via the distributed storage and/or directly from device to device, but may generally do so according to preconfigured user permissions.

Each ambient device may be user-configured according to user-preferred permissions. For example, devices with cameras, microphones, Internet access, and/or other sensor-based ability may be configured according to the user-preferred permissions. Such permissions may be time-based and user-controlled. In some implementations, user devices may be configured to prompt the user to review or edit permissions given to the device to ensure that the user is able to quickly modify permissions and device abilities.

The depicted door lock device 104 may include at least a sensing capability to lock and unlock a door from a received signal. The depicted security device 106 (e.g., security camera) may include one or more onboard devices and/or sensors, such as camera sensors, audio sensors, motion sensors, speakers, etc. The security device 106 may be located outside the home, but may still be associated with the user environment, which is associated with the distributed ambient computing system 100. The depicted smoke detector device 108 may be located in any number of locations throughout the user environment. The smoke detector device may include audio sensors, photoelectric sensors, and/or ionization sensors. The depicted occupancy sensor device 110 may determine whether or not movement is occurring in a particular location near the device 110. Device 110 may include optical electric sensors that detect motion and/or presence. Such sensors may use infrared, ultrasonic, microwave, and/or other signal sensor to detect presence of users within a defined environment. Detected user presence may be a trigger to modify the environment, if for example, device 110 includes (or has access to) a thermostat device.

The environment hub device 112 may be a smart display that includes any number of audio sensors, speakers, microphones, Internet (or other network) access, etc. As used herein, a “smart” device may represent an electronic device which may be communicably coupled with other electronic devices, networks, systems via particular wired or wireless protocols including, but not limited to Bluetooth, Zigbee, NFC, Wi-Fi, LiFi, Wireless USB, wireless Ethernet, cellular, etc.

The device 112 may function as an assistant device to carry out user-requested tasks including, but not limited to, searches, drafting documents, obtaining and playing audio and/or visual content, configuring other home devices, placing phone calls, just to name a few examples. The assistant device 114 may include any number of audio sensors, speakers, microphones, Internet (or other network) access, etc. Such a device 114 may also to carry out user-requested tasks including, but not limited to, searches, drafting documents, obtaining and playing audio and/or visual content, configuring other home devices, placing phone calls, etc. The audio/microphone device 116 may be found in any number of locations throughout the user environment. The device 116 may include audio sensors, speakers, and a microphone, etc. Any of the sensors associated with each device are configured to function and/or operate according to preconfigured user permissions.

The ambient devices 104-116 may include a portion (or in some examples all) devices associated with a location. Such devices may or may not include personal devices such as one or more of a mobile phone, a tablet, a personal computer, or a laptop, for example. For example, one or more personal devices may be part of the distributed ambient computing system if the user configures such devices to interconnect others of the ambient devices 104-116 (or other similar devices available in the user environment).

The user 102 may wish to perform tasks that involve one or more of the devices shown in FIG. 1A. For example, the user may be exiting the home and may wish to engage security measures. As shown in FIG. 1A, the user may utter a task (or select a task in a UI of a computing device). The task may be uttered or selected by the user using a computing device executing on the platform described herein. The computing device may, for example, include assistant device 114 or device 116 that may be executing an O/S capable of interpreting commands to and from the platform. In this example, the uttered task 118 (i.e., protect my house) may trigger device 114 to organize the uttered task 118 amongst one or more of ambient devices 104-116. For example, upon receiving the task 118, device 114 may assess which devices in the system are capable of protection measures (e.g., security tasks). The device 114 may also determine particular proximities for devices, which may be used to assess which devices to engage security measures upon.

For example, a smart light bulb in an attic with no windows may not need to engage security measures using an onboard proximity detector that may send a signal when in use. Instead, the device 114 may have a policy set by the user to not include such devices in a security tasks. The device 114 may turn on security features for the devices determined to have security capabilities and that follow the policy for the home, for example. In operation, device 114 may send signals and log such signals in the distributed storage, to trigger devices 1104, 106, 108, 110, 112, and 116 to carry out security engagement for the home. Each engaged device may also log the signals in a respective distributed storage associated with each respective device. Each distributed storage may synchronize to a master household distributed storage such that decisions may be made using the master household distributed storage.

FIG. 1B is a block diagram of an example distributed ambient computing system 128, in accordance with implementations described herein. The systems and methods described herein may leverage devices operating on any number of platforms. In conventional systems, computing devices and electronic devices, in general, may be optimized to perform tasks on a particular hardware. The systems and methods described herein may provide an advantage of convenient device management by configuring devices as interchangeable modules of a larger computer that conceptually encompass the available devices within a location, for example, to distribute computing tasks that may have been otherwise difficult to achieve using a single device.

For example, devices 112 and 114 (FIG. 1B) may be operating on a first platform 130 (e.g., executing a first operating system) which may receive input from any number of devices (e.g., mobile device 132, device 134, device 136, device 138, device 140, and/or device 142), any of which may be operating using a second, third, fourth, etc., platform (not shown) executing a second, third or fourth, etc. operating system. Devices 112 and 114 may also provide output to any number of devices (e.g., mobile device 132, device 134, device 136, device 138, device 140, and/or device 142). The platform 130 may utilize devices 112 and 114 to adapt content (e.g., visual content, audio content, data content, configuration information), across devices 132-142, for example. The platform 130 may assess, determine, calculate, or otherwise determine how to arrange, rearrange, present, execute, and/or otherwise handle content (or tasks) between devices 112 and/or 114 and another device within the system 128. The platform 130 may leverage other devices outside of the platform 130 by configuring such devices to function as input and/or output to the platform 130.

The systems and methods may utilize determined device capabilities that are associated with proximate (e.g., nearby) computing devices (e.g., electronic devices). Such devices may be determined as proximate if, for example, the devices are detected within a threshold distance of a particular defined environment (e.g., location). The example depicted in FIG. 1B includes devices 112, 114, 132, 134, 136, 138, 140, and 142, but any number and types of electronic devices may be substituted to take advantage of the systems, methods, and platforms described herein.

One or more of the computing devices described herein (e.g., devices 112 and device 114) may include distributed ambient computing logic to enable execution of computing tasks using one or more of the proximate devices (e.g., devices 132-142). An operating system executing on one or more of the computing devices 112 and/or 114 may enable any number of the devices 132-142 to share (e.g., distribute) computing and/or other device tasks, according to detected capabilities of the proximate devices and based upon received request(s) to execute particular tasks. By defining a predefined distance from the particular location, a network of devices may be identified and grouped to selectively perform user requested tasks according to combined device capabilities, predefined policies and preferences, and/or user context.

In general, the devices and computing systems described herein can determine a proximity from other devices in the user environment or to a user associated with the request to execute the task. For example, a portion of the devices and computing systems may have line-of-sight sensors that may determine whether particular devices are proximate to another device, which can enable a self-identification of proximity or a detected identification of proximity. In some implementations, the devices and computing systems may be assigned to a specific location and as such, the location may be used to identify physical proximity to another device or system. The determined location may be reassessed and/or re-determined to determine whether or not particular devices have moved within the ambient computing environment. In some implementations, determining proximity of a particular device or system may include measuring communications. For example, each device may be connected to a network with an identifier that may be used in combination with sending communication packets amongst one or more devices to assess or determine roundtrip packet times. Such times may be ranked to provide an indicator for which device is closer (i.e., more proximate) to one device (or user) than another device (or user).

FIG. 1C is a block diagram of an example distributed ambient computing system 150, in accordance with implementations described herein. The devices depicted in computing system 150 include an assistant device 112, an assistant device 114, a camera device 134, a thermostat device 138, a camera device 140, a lighting device 142, and a television device 144. The platforms described herein may be used to generate a distributed ambient computing system amongst any number of devices to adapt experiences to such environments. For example, the platform may determine that an assistant device 114 includes microphone input and search capabilities that may be adapted to function with the television device 144 and the camera device 134 to generate a video chat rig in which microphone, Internet connectivity, and dialing capabilities within assistant device 114 may be combined with camera device 134 and the display of television device 144 to enable a sophisticated communication system. The systems and methods described herein can utilize the platform to generate connect-ability within the distributed ambient computing system 150, as shown by arrows 152, 154, and 156. Policies can be generated for the combined devices 114, 144, and 134. The platform described herein can be used to adapt the policy to the devices and/or to another device determined to provide additional capabilities for requested tasks.

In some implementations, combining device capabilities may enable one device to be updated with functionality from another device. For example, a speaker device (e.g., such as assistant device 114) may be combined with a display device (e.g., smart display device 112) to provide security capabilities for a defined environment.

Although a few different devices are shown in FIGS. 1A-1C, any number of computing devices (e.g., ambient devices, personal computing devices, electronic devices, etc.) may be configured to operating using the platforms and distributed ambient computing systems described herein. Because such devices are defined according to inputs, outputs, and device capabilities, the systems and methods described herein may utilize the device capabilities according to task requests and policies associated with the environment and/or one or more of the devices.

As used herein a defined environment (e.g., user environment, home) may include a household defined based on one or more of associated users, rooms, square footage, recognized and/or configured devices, and/or other elements associated with a household. In some implementations, the defined environment may include a building, a user-defined perimeter, a yard surrounding a home, an apartment, a condominium, a set of buildings, or a room, just to name a few examples.

The devices (e.g., electronic devices and/or computing devices) described herein may include, but are not limited to smart displays, televisions, mobile devices, tablets, computers, game controllers, lights, alarm clocks, electronic assistants, smart watches, smart phones, thermostats, appliances, fans, switches, sprinklers, air fresheners, blinds, awnings, shutters, curtains, windows, garage door openers, showers, security systems, electronic doorbells, cameras and devices having cameras, electronic locks, smoke detectors, proximity sensors, Internet connected speakers, laptops, desktops, workstations, cars, or other device which may communicate information.

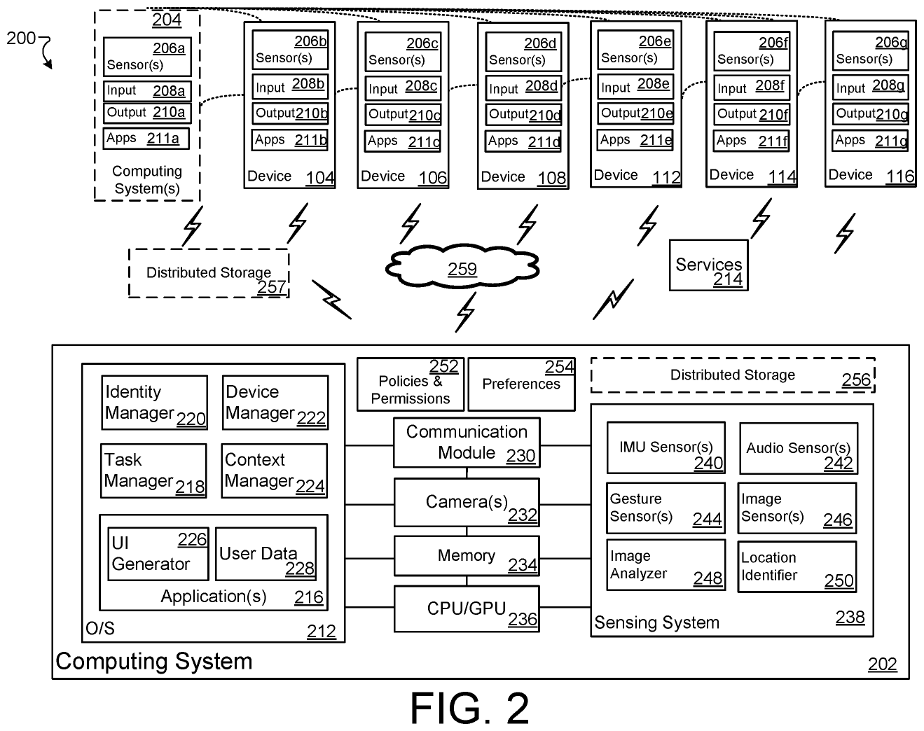

FIG. 2 is a block diagram illustrating an example distributed ambient computing system 200 including multiple devices, in accordance with implementations described herein. The system 200 may be used to configure computing devices (e.g., computing system 202 and computing device 204), ambient devices (devices 104, 106, 108, 112, 114, and 116), and/or other mobile devices (not shown in FIG. 2) to function as a single distributed computing environment, such that tasks may be dispatched and/or shared amongst any of the devices within the distributed ambient computing system 200. For example, system 200 may be able to recognize and describe each device in each room of a particular environment for purposes of obtaining inputs, controlling device functionality and/or processing, and providing outputs, regardless of the underlying operating system executing on each device.

In some implementations, the multiple devices may include any number of applications that may be formed dynamically from available software components (and functionality) available in the distributed ambient computing system 200, for example. The applications may provide dynamic interoperability that operates on a platform that is operating system independent.

As used herein, a distributed ambient computing system may refer to a network of multiple (e.g., two or more) autonomous computing devices, mobile devices, ambient devices, personal handheld devices, sensors, and the like, that may communicate amongst one another and/or other devices configured for the network. The network may be a predefined network, an autonomously generated network, a peer-to-peer network, or other network that allows data to be transferred between devices in the network using protocols such as UPnP, SLP, or GSM, just to name a few examples. The distributed ambient computing system may provide coordinated use of shared resources, communication infrastructure, UI elements, and/or services to carry out tasks and requests received from a user associated with one or more of the devices defined for a distributed ambient computing environment. As used herein, a distributed ambient computing environment may refer to a defined physical space that has access to resources, communication infrastructure, UI elements, and/or services available to devices configured in the distributed ambient computing network.

Each device in a particular distributed ambient computing system (e.g., devices 104, 106, 108, 112, 114, 116, and 204 in the example of FIG. 2) may be defined by capabilities associated with such devices including, but not limited to respective device capabilities (from sensors 206a-206g, input 208a-208g, and output 210a-210g) and a respective device location within a defined user environment. The computing system 202 may be configured to dynamically distribute tasks across any of devices 104, 106, 108, 112, 114, 116, and 204, for example.

The sensors 206a-206g may represent device capabilities. Any number of sensors may be available on the devices described herein. In addition, if a particular sensor is unavailable on one device, another device may provide the sensor to perform (e.g., execute) a capability requested within a user-requested task. Example sensors may include, but are not limited to optical sensors, image sensors, audio sensors, motion sensors, proximity sensors, temperature sensors, infrared sensors, ultrasonic sensors, touch sensors, pressure sensors, level sensors, smoke and/or gas sensors, chemical sensors, accelerometers, gyroscopes, environmental sensors, etc.

The input 208a-208g may include, for example, content received via a touch input device that can receive tactile user inputs, a hand controller, a mobile device (or other portable electronic device), a microphone that can receive audible user inputs, and the like. The output 210a-210g may include, for example, generation of content for a display for visual output, a speaker for audio output, and the like.

In some implementations, each device 104, 106, 108, 112, 114, 116, and 204 includes a number of apps 211a-211g. The apps may utilize services 214, policies and permissions 252, preferences 254, and a distributed storage 256. The policies and permissions 252 may pertain to device permissions, device policies, user permissions, user policies, etc. The distributed storage 256 may be on device 202 (or other device) as a local copy, but may also be updated via a public or private network, an Internet connected network, or other network. Synchronization can occur between the two distributed storage logs, for example, storage 256 and storage 257.

In a non-limiting example, the system 200 may determine inputs, outputs, and capabilities of devices in the system and make a determination as to which device may be used to carry out a task, display information, etc. For example, a camera device may include a video input and a microphone input, but may not include output capabilities. In addition, device processing power for the camera device may also be limited. A television device associated with the same system 200 may have a microphone as input and may have a larger display than the camera display and thus may provide convenient visual output to a user instead of providing visual output on the camera device. Other devices, such as a Wi-Fi router or a smart display, may have similar or different inputs and/or outputs, but may have additional processing power and/or memory, and as such may be selected by system 200 to perform processing for another device in the system 200. In operation, system 200 may dynamically determine which device is suited to fulfill a user requested task.

In some implementations, the computing system 204, and devices 104-116 may include the components shown in computing system 202. In such an example, each computing system and device may be used to assess capabilities and/or distribute tasks amongst devices 104-116. For example, computing system 204 may be an assistant device with image sensors, audio sensors, and Internet connectivity. Computing system 204 may be located in a basement location within a defined household. The computing system 200 may access any of devices 104, 106, 108, 112, 114, and 116 as well as computing system 202 to perform and/or share tasks execution. For example, if a user in the household requests via system 204 to play a movie in the kitchen location associated with the household, then the computing system 204 may assess the capabilities available amongst any of the devices associated with the household to determine which devices have the capability to play a movie. In this example, the system 204 may determine that assistant device 112 located in the kitchen and a second device 144 located in a living room of the household may have the capability of playing the movie. In response, the system 204 may determine that the assistant device 112 is a device in the proper location (in the kitchen) and having the requested capability (e.g., play a movie). Thus, the computing device 204 may trigger the movie for streaming on the assistant device 112. Similarly, device 104 may include the components shown in computing system 202. As such, device 104 may be used to perform, share, and/or distribute tasks within and amongst devices in distributed ambient computing system 200.

In general, the computing devices 202 and 204 and devices 104-116 may communicate and/or transfer data wirelessly amongst one another using the systems and platforms described herein. In some implementations, each device may be configured in the distributed ambient computing system 200 to communicate with each device associated with system 200.

As shown in FIG. 2, the computing system 202 includes an operating system (O/S) 212. The O/S 212 may function to execute and/or control applications, services, and device communications. The O/S 212 may be a first type of operating system while other devices shown in FIG. 2 (or associated with a particular distributed ambient computing system) may be a different operating system operating different device hardware.

In operation, the systems and methods described herein may provide access to one or more services 214 for any number of different device types that may be within a distributed ambient computing system 200 (e.g., in a household), for example, where each device may be executing a different operating system. The services 214 may be configured to generate, manage, and execute tasks detected (e.g., received) in the distributed ambient computing system 200. In addition, the services 214 may provide O/S level access to detect peripheral (e.g., ambient) devices and capabilities. The services 214 may be an O/S level executive decider to dispatch one or more tasks received in system 200.

The services 214 may include personalized computer-based services provided by a service provider to a user. In some implementations, the services may not be personalized, but may instead be general services offered to users for use on their computing and/or electronic devices. In some implementations, the services may be provided via an app (e.g., application) at the request of the user.

The O/S 212 may execute and or otherwise manage applications 216, a task manager 218, an identity manager 220, a device manager 222, and a context manager 224. The applications may include a user interface (UI) generator 226 and user data 228, both of which may be used to generate content and/or data and provide such content and/or data to the users via a device interface.

The task manager 218 may manage distribution of tasks throughout a distributed ambient computing system 200. For example, the task manager 218 may assess tasks and device capabilities in order to trigger completion of the tasks using one or more of the devices in the system 200.

The identity manager 220 may manage identities associated with the system 200. For example, a user may be associated with a device using an identity. The identity may be associated with an identity account, but such an account is user controlled and generated, rather than service provider controlled and generated. Each identity may be represented as a globally unique identifier. In addition, each identity may be represented with a persona, which may be used to present the user (or data associated with the user) to third parties or other devices in system 200, for example. In general, the identity manager 220 may be used to add and/or modify users, home services, physical buildings, and devices. For example, the identity manager 220 may generate an account that may represent a physical building (e.g., a home). The identity of the home may include an address and other identifying data in which a user may claim ownership. The identity of the physical building is typically not directly connected to a human user or a service provider, but instead corresponds to an account set up by the user for the home.

In an example, a user may claim ownership of a particular physical building. In response, the identity manager 220 may generate a connection between the physical building, the location, and one or more users within the household associated with the building. For example, the identity manager 220 may be asked by the user to set up additional users to associate (i.e., relate) with a household corresponding to the physical building. The identity may include such relationships and the system 200 may assign rights, policies, and preferences based on such relationships.

The device manager 222 may manage and assess device status and state within the system 200. In some implementations, the device manager 222 may set up devices for particular environments. For example, one or more setup APIs may be embedded and/or otherwise utilized by a setup application, which may be used by the device manager of any particular device in system 200 to present brand expression aspects (e.g., UI content per device brand) while still assuring interoperability with other ambient computing devices in system 200, regardless of the underlying operating system of the devices.

In some implementations, the device manager 222 may provide, or otherwise enable, device to device setup. For example, smart home devices may communicate via peer-to-peer networks (or other networks via ultrasound or other wireless technology) upon user confirmation via a previously provisioned device identity. Upon confirmation, the previously provisioned device may communicate services, preferences, and/or settings to one or more of the smart home devices, for example. Thus, manual Wi-Fi setup, device setup, or other out of the box setup tasks may be rendered unnecessary.

In some implementations, device manager 222 may provide modular out of the box experiences so that particular device functionality can be individually activated and/or re-ordered depending on the device a user previously configured and based on information associated with the previous device configuration. The device manager 222 may then reuse information associated with an initial device setup when a user asks for experiences that involve a new setup.

The context manager 224 may assess the circumstances that form a setting for an event, a statement, or an idea. The context manager 224 may define such a setting in terms of which it can be fully understood and assessed. For example, the context manager 224 may provide context-aware computing amongst devices in the distributed ambient computing system 200. For example, the context manager 224 may use software and/or hardware to collect and analyze data about device surroundings in order to present relevant, actionable information to a user of the device. The collection and analysis occurs according to user permissions and within the location associated with the device unless a user requests to use additional resources outside of the defined location. In some implementations, the context manager 224 may collect signals from individual devices, analyze and combine signals into a home-wide context; and notify services and other parts of the systems (e.g., devices) of changes in the context according to system and/or device permissions.

As shown in FIG. 2, the O/S 212 may include or have access to services 214, a communication module 230, cameras 232, memory 234, and CPU/GPU 236. The computing system 202 may also include or have access to a sensing system 238. The sensing system 238 includes inertial measurement unit (IMU) sensors 240, audio sensors 242, gesture sensors 244, image sensors 246, image analyzer 248, and location identifier 250. The sensing system 238 may have access to communication module 230, cameras 232, distance/proximity sensors (not shown), positional sensors (not shown), and/or other sensors and/or different combination(s) of sensors. Some of the sensors accessed by system 212 may provide for positional detection of a device associated with the system 200 or a user of the system 200. Some of the sensors of system 238 may provide for the capture of images of a physical environment associated with the distributed amendment computing system for display on a component of one or more of devices 104, 106, 108, 112, 114, 116, and/or 204.

The IMU sensor 240 may function to detect or measure, for the computing system 202, an angular velocity and linear acceleration. The system 202 may then calculate and/or estimate a 3D orientation in 3D space based on the measurements taken by the IMU sensor 240. The IMU sensor 240 may include one or more accelerometers, gyroscopes, magnetometers, and other such sensors. In general, the IMU sensor 240 may detect motion, movement, velocity, and/or acceleration of the device 202, for example.

The image sensors 246 may detect changes in background data associated with a camera capture performed by device 202 (or another device in communication with device 202). The cameras 232 may include a rear-facing capture mode and a front-facing capture mode.

The computing system 202 may generate and/or distribute particular policies and permissions 252 and preferences 254. The policies 252 and preferences 254 may be configured by the device manufacturer or by the user. Policies 252 and preferences 254 may include routines (i.e., a set of actions) that trigger based on an audio command, a visual command, a schedule-based command, or other configurable command. For example, a user may set up an evening routine with preferences and/or actions to trigger devices in a predefined location to lock one or more doors, turn on or off one or more cameras, and turn off lights. A received command may trigger such a routine. Other policies and preferences may of course be configured to modify and or control other devices associated with a particular location configured with the policies and permissions 252 and/or preferences 254.

In some implementations, the computing system 202 may access the distributed storage 256 (and/or distributed storage 257) to maintain device statuses and task statuses during operation of the distributed ambient computing system 200. Such distributed storage 256 (and/or distributed storage 257) may represent a distributed storage system. In some implementations, the distributed storage 256 (and/or distributed storage 257) may be provided as a service 214. Such a service may be synchronized across the devices owned by a particular household, building, user, etc. In some implementations, the distributed storage 256 (and/or distributed storage 257) may be provided via an application.

Each application 216 and/or component executing on behalf of a particular defined user may have a separate data store provided and managed by the distributed storage (e.g., log) 256, for example, and provided to other user associated devices, as requested by the user. The data store for the particular component/user combination is private to the user and thus not accessible to other applications of the same user, and not accessible to other users of the same application (or another application). Each data store may be transparently synchronized across devices associated with a user through a network resource provider (e.g., network 259, for example). Any data operations may be executed offline-first with no coordination with the network. If concurrent modifications result in a data conflict, the conflict can be resolved using an app-configurable merge policy, for example.

In some implementations, the distributed storage 256 (and/or distributed storage 257) implementation includes storage (not shown) that stores and provides access to the data locally, client components that interact with storage, and a local client that exposes the distributed storage 256 API to locally running applications (e.g., applications 216).

In operation, the distributed storage 256 may operate locally for the application 216 and may not synchronize data with the network 259 and distributed storage 257 if the application is operating in guest mode. If the application 216 is operating in standard mode, the distributed storage 256 may synchronize user data using a network instance via network 259. In general, the network 259 may provide hybrid network services or public network services. Hybrid network services may be generated, provided, and/or serviced by a hybrid network solution vendor. Public network services may be owned and operated by a service provider that manages public networks.

The distributed storage 256 may provide for carrying out transactions that allow an application (e.g., application 216) to make a set of changes that may be synced and surfaced. For example, the computing system 202 (e.g., a client device) may start a transaction, obtain a snapshot of the page state, and read the data. The computing system 202 (via application 216, for example) may then make changes through a page interface of the distributed storage 256, and may commit the transaction. Once a transaction is started, the state of the page is tracked and pinned so as to not advance until the transaction is either committed or aborted. This may provide an advantage of ensuring that the transaction writes affect precisely the state visible on a snapshot of the page. In some implementations, the distributed storage 257 may operate as a master household distributed storage in which the configured household devices may share (and synchronize) data to/from respective distributed device storage, such as distributed storage 256.

Each device within a particular distributed ambient computing system may include one or more processors (e.g., CPU/GPU 236) in communication with the O/S 212, the sensing system 238, the communication module 230, services 214, memory 234, and/or cameras 232. The communication module 230 may provide for communication between the computing system 202 and other external devices. Processors 236 are configured to execute instructions (e.g., computer programs) in order to carry out specific tasks. In some implementations, at least one of the processors 236 executes instructions to operate devices in a distributed ambient computing system. Memory 234 may be utilized throughout communications and interactions amongst the elements in system 200.

In addition, the computing system 202 may use or have access to one or more peripherals (not shown). Example peripherals may include any number of controllers, computing devices, head-mounted display devices, cameras, speakers, tracking systems, and/or other device in communication with device 202.

In some implementations, the computing system 202 includes or has access to a tracking system (not shown). The tracking system may include (or have access to), for example, light sensors, inertial measurement unit (IMU) sensors 240, audio sensors 242, image sensors 246, image analyzer 248, location identifier 250, cameras 232, distance/proximity sensors (not shown), positional sensors (not shown), and/or other sensors and/or different combination(s) of sensors.

Various solutions to the problems noted above are provided by a computing system, in accordance with implementations described herein. A computing system, in accordance with implementations described herein, may leverage data collected by various sensors and/or devices included in the distributed ambient computing system(s) to generate (e.g., build) networks of devices that function with services and a platform to detect, identify, and/or rank devices available and capable in a home environment. Such a service may make decisions (e.g., based on user requests or user-configured permissions) to dispatch and/or orchestrate tasks across the available devices in the distributed ambient computing system(s). Additional details regarding the services and platform are described below.

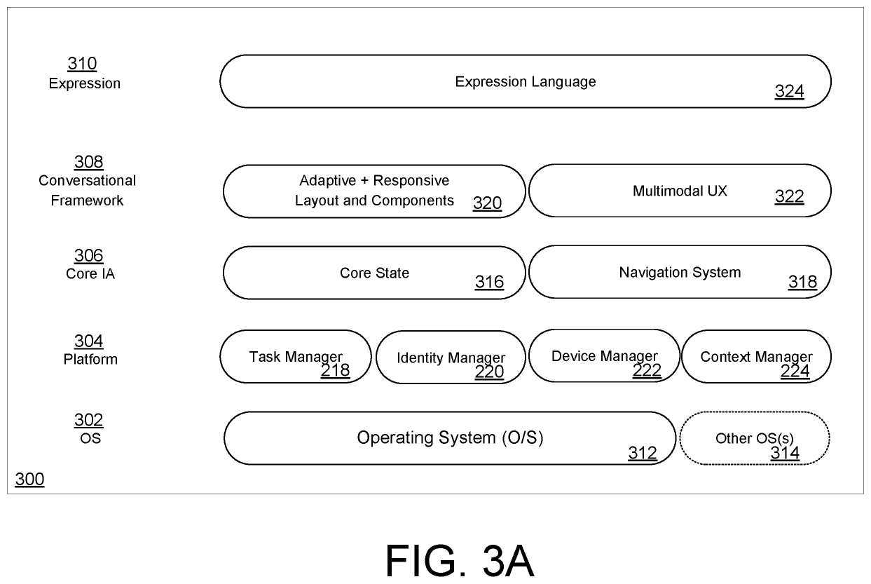

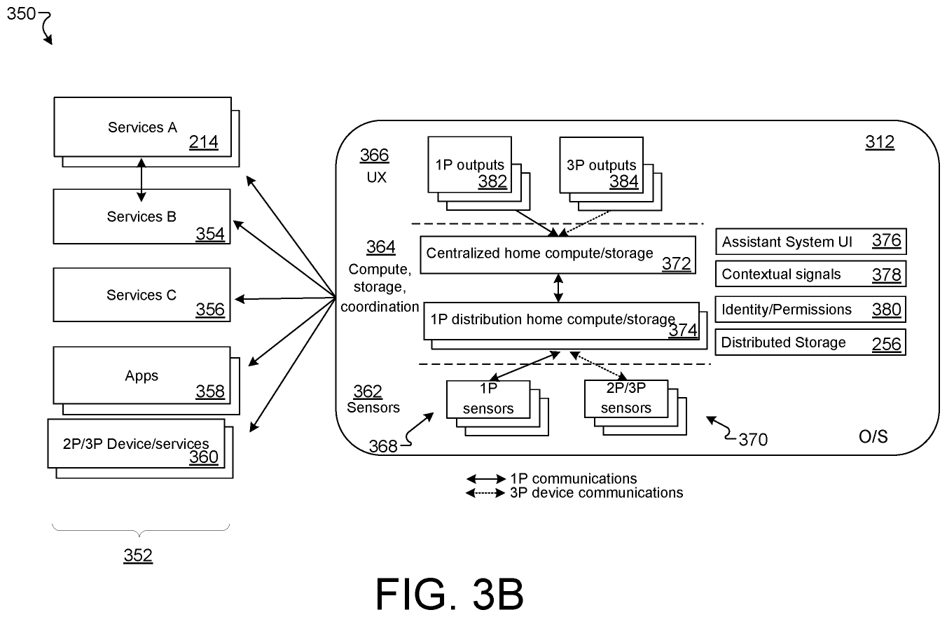

FIG. 3A is a block diagram illustrating an example architecture 300 for operating a distributed ambient computing system, in accordance with implementations described herein. The architecture 300 may provide a uniform structure across the devices executing different operating systems. Each device may have access to unified UI content to allow for device brand recognition, etc.

As shown in FIG. 3A, the architecture 300 includes an operating system (O/S) layer 302, a platform layer 304, a core information architecture (IA) 306, a conversational framework 308, and an expression language 310. The O/S layer 302 includes an O/S 312 and optionally other operating systems 314. The O/S 312 may represent an operating system that computing system 202 and/or computing system 204 may be operating upon. The O/S 312 may be used to direct (e.g., distribute) tasks to other devices within a particular defined environment. The other operating systems 314 may be utilized as inputs and/or outputs from/to devices in the defined environment that are not operating on the operation system 312 (e.g., devices 104, 106, 108, 112, 114, 116, etc.).

The platform layer 304 includes the task manager 218, the identity manager 220, the device manager 222, and the context manager 224, as described in detail above with respect to FIG. 2. In general, the identity manager 220 may be used to add and/or modify users, home services, and devices, each of which may be represented at a same level within the platform layer 304. The platform layer 304 may represent the platform described herein which may communicate information between the O/S layer 312 and the core IA 306.

Because a number of devices (operating with different hardware and software) may include duplicative functionality, the platform layer 304 may be used to assess, manage, and configure such devices to orchestrate tasks requested by the user (or requested from the user using another of the devices) based on a defined identity of the user. For example, the identity manager 220 may be used to generate and use an identity for entities, including, but not limited to, a building, a user, a household, a business, etc. The device manager 222 may be used to generate an account representing such entities. The identity for particular entities may be a replacement, for example, for a service provider account that is stored, owned, and serviced by the provider. The identity may be owned and maintained by the user, rather than owned and maintained by a service provider.

Referring again to FIG. 3A, the core (IA) 306 includes at least a core state module 316 and a navigation system 318. The core state module 316 assesses and determines a core state of the components of each device in a distributed ambient computing system 200, for example. The navigation system 318 may determine in which state a particular device is in so that the system 200 may share such information with other devices in system 200.

The conversational framework 308 includes an adaptive and response layout and components module 320 and a multimodal User Experience (UX) module 322. Module 320 may ensure that UI content generated by core IA 306 can adapt and respond with particular software and/or hardware components for each device in the system 200. The multimodal UX module 322 may generate UI content to ensure that a user is provided a seamless and device-specific experience while utilizing the distributed ambient computing functionality of system 200. The expression language 310 may include an expression language 324 that may be used to generate UI content for devices providing content to users and/or other devices associated with the distributed ambient computing system 200, for example.

In operation of architecture 300, the core IA layer 306, the conversational framework 308, and the expression language 310 may function together with the platform layer 304 and the O/S layer 302 to ensure that system 200 has the same information architecture and the same set of states, and components across the devices associated with a particular distributed ambient computing system. The architecture 300 may then display content according to a UX design adopted across the devices, while allowing for device-specific UI content and/or UX scenarios. For example, a user may request a task via a smart watch, which is displayed on a smart hub in a different room. The displays may be cohesive and similar, yet may depict different color schemes, elements, or other UI content based on the device, a manufacturer, a policy set up for the system, a preference set up for the system, etc.

FIG. 3B is an example architecture 350 for operating a distributed ambient computing system, in accordance with implementations described herein. For example, the architecture 350 may be used to operate distributed ambient computing system 200. The architecture 350 may include O/S 312 and any number of elements 352 provided by service providers, developers, and/or device manufacturers.

The elements 352 include services 214, electronic services B 354, electronic services C 356, apps 358, and second party (2P) and third party (3P) devices and/or services 360. In some implementations, 3P devices may include configuration APIs that allow original equipment manufacturers (OEMs) to embed brandable components into a device setup flow to ensure that the OEM branding is present during product configuration.

For example, 3P device configurations typically take users into different apps and web flows that utilize multiple identities and/or passwords. Each particular 3P device may configure devices differently (e.g. pairing, nomenclature, maintenance), which may introduce difficulty in configurating devices and may cause data inconsistency across devices. With more and more diverse and lower fidelity devices coming to market and with no holistic or consistent setup solution, users often are forced to set up hardware bridges or intermediary apps, which may make hardware and device ecosystems fragmented for users. This can cause 3P devices feel incompatible. With the system 200, architecture 300 and 350 described herein, a platform can be used to recognize device product keys and new devices may inherit the naming and structure languages of the location associated with the system 200, for example.

The platform described herein may allow nearby 1P devices to serve as a hub for communication and processing for such 3P devices. In addition, the platform may enable OEMs can use a setup API that allows the OEMs to flexibility maintain their brand while keeping out of the box experience consistent amongst devices at the location. Providing a modular out of the box experience with embeddable, branded components can enable basic permissions without visually leaving the setup/configuration flow.

The services 214 may represent device services provided by OEMs, service providers, account providers, etc. In some implementations, services may include physical pairing services for devices. Such services may ensure that consistent standards for pairing can be expressed through device packaging, device materials, device sensors, and/or device software.

The electronic services B 354 may include responsive audio information, task completion, and/or communication access in response to user-requested tasks, commands, and/or other input. The electronic services C 356 may include use of the electronic services B 354 to receive real time feedback, reminders, information, and/or other user-requested content.

The apps 358 may be first, second, or third party apps useable with any of the devices within the distributed ambient computing system. The second party (2P) and third party (3P) devices and/or services, device elements, and services executing operating system 314 (or another O/S that is not encompassed by O/S 312). For example, the second party (2P) and third party (3P) devices and/or services 360 may be manufactured, provided, and or otherwise offered by a second party or third party that is not the manufacturer of the hardware and/or software of a respective device or of the respective device receiving the 2P and/or 3P services.

The O/S 312 shown in FIG. 3B may include (or access) portions of system 200 and architecture 300. The O/S 312 includes a sensor layer 362, a compute/storage/coordination layer 364, and a UX layer 366. The sensor layer 362 includes any number of first party (1P) sensors 368 and any number of 2P sensors and/or 3P sensors 370. The 1P sensors 368 may include sensors that are designed for the device executing O/S 312 (or O/S 212), for example. The 2P and 3P sensors 370 may include sensors and/or device elements executing operating system 314 (or another O/S that is not encompassed by O/S 312).

The compute/storage/coordination layer 364 may include a centralized home (e.g., household) computation and/or storage resource 372, a 1P distribution home (e.g., household) computation storage resource 374. The centralized home (e.g., household) computation storage resource 372 may function with the distributed storage 256 and other device and/or network-based distributed storage to coordinate device storage and synchronization. The 1P distribution home (e.g., household) computation and/or storage resource 374 may function to store data about 1P sensors 368.

The layer 364 also includes access to an assistant system UI 376, contextual signals 378, identity and/or permissions 380, and the distributed storage 256. The assistant system UI 376 may include UI content provided via an assistant or other device so the user may be provided information and may input other information. The contextual signals 378 may include signals determined at the device level which may be used to implement policies, rules, and device actions. The identity and/or permissions 380 may be rules and/or data that may be used to identity devices and users within the household as well as any permissions associated with such users.

The distributed storage 256 may maintain device statuses and task statuses during operation of the distributed ambient computing system 200. Such distributed storage 256 may represent and/or provide a distributed storage system for distributed ambient computing system 200. In some implementations, the distributed storage 256 may be provided as a service 214. Such a service may be synchronized across the devices owned by a particular household, building, user, etc. In some implementations, the distributed storage 256 may be provided via an application.

In operation, architecture 350 may provide a cohesive home space for users to operate devices within. When users interact with their homes and associated devices, the users may be interacting with different aspects of a single household, and thus each home utilizing architecture 350 can be operated by a single digital assistant using assistant system UI 376, for example. In some implementations, such a UI 376 may correspond with the first digital assistant device purchased for the home. As such, the first digital assistant device may be the user's ecosystem for the home.

The platform 304 may function with O/S 312 to provide a distributed ambient computing system in which each associated device is thought of as a collection of capabilities (e.g., 1P sensors and 3P sensors), rendering layers (e.g., UX layer 366), and compute (e.g., layer 364). The O/S 312 may orchestrate different devices depending on their capabilities to deliver a desirable cross-home experience. Because home experiences are inherently communal and oriented toward family relationships, the O/S may respect the relationships in the home while offering the users in the household a unique personal experience.

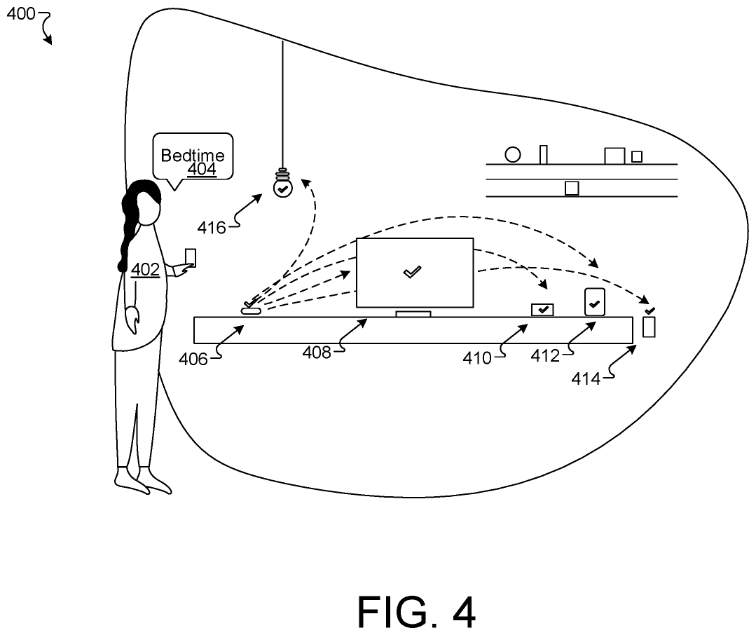

FIG. 4 is an example diagram illustrating a task request and execution of a task in a distributed ambient computing system, in accordance with implementations described herein. As shown, a user 402 may have associated any number of devices with a particular location 400 (e.g., her home). The configuration of such devices is described throughout this document.

Because managing a multidevice home can be unwieldy, a single assistant device may be used to bridge gaps that may occur between devices associated with the home at location 400, for example. Each device and infrastructure may have a separate interface and preferences. The single assistant may function to provide communication infrastructure, UI elements, and user data between devices, infrastructures, and services associated with the devices to enable devices associated with the home location 400 to work together while providing simple user control of such devices. In general, the single assistant may operate using O/S 212/312 and architecture 300 and/or architecture 350 to adapt content across devices.

Referring again to FIG. 4, at some point, the user 402 may request a task to engage one or more devices including, but not limited to, an assistant device 406, a television 408, an alarm clock 410, a tablet 412, a mobile phone 414, and a light 416. For example, the user 402 (shown in FIG. 4) uttered a “bedtime” task 404. In response, the system 200 may use architecture 300 and/or architecture 350 to execute bedtime related tasks for devices 406-416. For example, the distributed ambient computing system (e.g., system 200) set up for location 400 may determine that one of the devices 406-416 is capable of triggering other devices in location 400 to carry out the uttered task. Here, the assistant device 406 is shown as the device to receive the user requested task 404. The assistant 406 may receive the task based on a condition, policy, or preference set by the user to either use assistant device 406 as a controller or to use a closest capable device as a controller of other devices. In some implementations, the system 200 may access a predefined proximity condition that may have been configured for the devices 406-416, for example, to utilize a device determined to be closest to a user as a controller device for other devices.

If the user's task 404 (e.g., a command) is received by the assistant device 406, device 406 (utilizing or operating as system 200) may determine which of devices 406-416 (i.e., including itself) are configured and/or capable of executing the task 404. In this example, the devices 406-416 may be configured and/or capable of triggering a nighttime mode that may correspond to particular user preferences 254 and/or policies and permissions 252 set up with the “bedtime” task 404. Any device determined to be capable and configured to perform a bedtime task may be triggered, by the assistant device 406 to execute the task 404. For example, the assistant device 406 may trigger the television 408 to shut off and/or change to a predefined nighttime mode. Similarly, the assistant device 406 may trigger an alarm to be set on the alarm clock 410 based on an accessed user schedule, a time of day, a day of the week, etc. In addition, the assistant device 406 may trigger the tablet 412 to shut down or shut off notifiers. The assistant device 406 may also modify functions on the mobile phone 414 to function in a nighttime mode. In addition, the assistant device 406 may shut off or dim other devices, such as the light 416. Each of the above changes may be triggered in combination or sequentially to carry out the user requested task 404.

Previous to uttering task 404, a user may have configured devices 406-416 with user information, scheduling information, etc. For example, the user may have configured mobile device 414 with user information, scheduling information, or other detected information, and mobile device 414 may share such information with devices 406-412, and 416 based on a previously configured distributed computing system that includes devices 406-416. Alternatively, a distributed (ambient) computing system may be set up at runtime and on the fly when the task is received. In some implementations, the distributed ambient computing system may include a subset of devices 406-416, for example, if it is determined that one or more of devices 406-416 may not be capable of carrying out a particular received task.

Other devices in location 400 may be present and capable of communicating with system 200, and as such, system 200 may perform other tasks set up under a command associated with task 404 including, but not limited to dimming other lights, changing a temperature, securing a door, activating or modifying occupancy security cameras, imposing volume limits on speakers and or television 408, for example. In general, users associated with home location 400 (and resulting distributed ambient computing systems configured for home 400) may generate and execute policies and preferences without having to explicitly configure each device. Thus, in some implementations, policies and preferences may be triggered at a particular user imposed hour without having to receive a user command, for example.

In general, system 200 or another distributed ambient computing system set up amongst two or more devices in a location may communicate and pass information amongst devices associated with the location, but may not share any of the information with devices that are not associated with the location. In addition, communications that occur amongst devices can be encrypted and/or otherwise cryptographically secured.

In some implementations, a number of different device networks may be set up (on a per room basis, for example). Such networks can communicate within the location to other networks within the location.

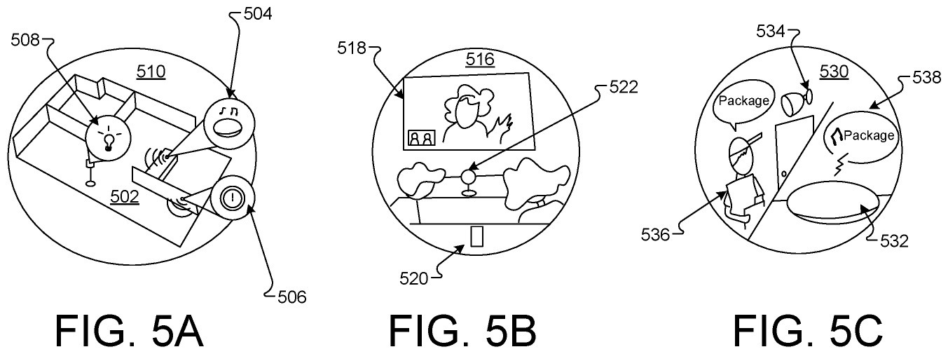

FIG. 5A is an example diagram depicting two or more devices executing a user requested task, in accordance with implementations described herein. As shown, a location 502 is defined by system 200, for example. The location 502 may be or represent a user environment including, but not limited to a home, a household, a residence, a business, etc. An assistant device 504 may detect for the location 502, a number of devices associated with location 502. Devices within the location 502 may be configured for a user as part of a particular household associated with location 502. For example, a thermostat device 506 and a light sensor device 508 may be detected as part of location 502. In some implementations, areas 510 surrounding location 502 may also be included as part of a user environment associated with location 502.

In general, the devices 504, 506, and 508 may provide home monitoring aspects using capabilities across non-security type devices. For example, the assistant device 504, the thermostat device 506, and the light sensor 508 may not be part of a security system, but each device may function to alert a user to changes within the home, thus providing security features.

In operation, the assistant device 504 may determine what devices 506 and 508 can execute with respect to device capabilities. Here, the device 504 may determine that the thermostat device 506 and the light sensor 508 both include capabilities such as proximity sensing and/or occupancy sensing. In response, the device 504 may configure the thermostat device 506 and the light sensor 508 as a distributed ambient computing system. In addition, the assistant device 504 may be included in the distributed ambient computing system. Each device 504, 506, and 508 may be defined according to at least one of the detected capabilities and according to a device location within the user environment of location 502 and/or areas 510. For example, each device 504, 506, and 509 may correspond to at least one of the detected capabilities and according to a device location within the user environment of location 502 and/or areas 510.

At some point, the assistant device 504 may receive a task from a user at location 502. Alternatively, the received task may be remotely received at the assistant device 504 from an offsite user (and associated user device) that may be associated with the distributed ambient computing environment. The task may be “provide a security update” or “who is home?” which may be in response to device 504, 506, and/or 508 detecting movement within the home.

In response to the task, the assistant device 504 may determine that two or more of the available devices associated with the location 502 may be useful to carry out the requested task. In response to determining that completing execution of the task indicates the use of two or more of the plurality of capabilities of the devices, the assistant device 504 may determine, within the distributed computing system, which of the additional devices is capable of executing the task. For example, device 504 may determine that devices 506 includes a camera and a proximity sensor for a first room, while device 508 incudes a proximity sensor for a second room.

Understanding movement in both rooms may provide an increased likelihood of correctly and accurately completing the user requested task. Thus, the assistant device 504 may select at least two devices (e.g., device 506 and device 508) to share execution of the two or more capabilities to complete the task. Selecting of the at least two devices may be based at least in part on a determined proximity of the two devices to the assistant device 504, for example. Upon completion of the above determinations, the assistant device 504 may trigger the selected at least two devices (device 506 and device 508 along with device 504) to execute the task. For example, upon gathering the data from device 506 and device 508, the assistant device 504 may communicate the information requested by the user in the received task.

In some implementations, selecting the at least two devices includes configuring devices 504, 506, and 508 to communicate to execute separate portions of the task. In some implementations, selecting the at least two devices includes determining which of the devices include components configured to execute the two or more capabilities to complete the task and configuring the at least two devices to communicate to complete the task.

In some implementations, at least one capability associated with at least one of the two devices extends a capability associated with the other of the at least two devices. For example, the thermostat device may capture movement of a user, but may not communicate such movement to the user unless communicating via assistant device 504. Thus, assistant device 504 extends the capability of thermostat device 506.

In some implementations, the execution of the task is triggered in the absence of Internet connectivity for the devices in the distributed (ambient) computing system. For example, devices 504, 506, and 508 may share information without the Internet and may provide information to the user via a mobile device when the user reenters the location 502. That is, the user may be nearing her front door and may request a task to her mobile device to determine which household members are home at the location 502. The mobile device may connect to devices 504-506 upon entering a boundary associated with the location 502 and may provide an answer to the user when the user is within a threshold range of the location 502.

FIG. 5B is another example diagram depicting two or more devices executing a user requested task, in accordance with implementations described herein. A location 516 is defined to include any number of devices located within range. Devices within the location 516 may be configured by system 200, for example, as part of a particular household associated with location 516, which may be used to generate a distributed ambient computing system. The location 516 may be or represent a user environment including, but not limited to a home, a household, a residence, a business, etc.

Here, two users are watching a television device 518. One of the user is associated with a mobile device 520. A camera device 522 is also shown in the scene. The television device 518, the mobile device 520, and the camera device 522 may be previously correlated to (e.g., associated with) the location 516.

At some point, an incoming video call is received at the mobile device 520. Such a call may represent a task requested of the distributed ambient computing system associated with devices at location 516. Here, the mobile device 520 may not be near to the users. Since devices 518-522 are configured as part of a distributed ambient computing system, any number of devices may be used (e.g., to substitute functionality) to send and/or receive input and output for the mobile device 520. In this example, the system 200, for example, may assess device capabilities for location 516 and may assess user proximity to such devices. The assessment may be used to determine that television device 518 may provide visual and audio output to the user from the mobile device 520 while camera device 522 can be used to capture and send visual and/or audio output to the caller on the mobile device 520. Although mobile device 520 may perform each of the tasks, the user is determined to be away from the device 520 and as such, the distributed ambient computing system may use other proximate devices associated with the distributed ambient computing system to conveniently provide substitute devices that may carry out the phone call task.

FIG. 5C is another example diagram depicting two or more devices executing a user requested task, in accordance with implementations described herein. A location 530 is defined to include any number of devices located within range. Devices within the location 530 may be configured by system 200, for example, as part of a particular household associated with location 530, which may be used to generate a distributed ambient computing system. The location 530 may be or represent a user environment including, but not limited to a home, a household, a residence, a business, etc.

In the depicted example, an assistant device 532, an exterior camera 534 may function together to alert a user to a delivery at a door of the location 530. For example, the exterior camera 534 may detect a package delivery from user 536 by capturing a visual image. The delivery captured by camera 534 may trigger a task to be performed by another device. For example, the camera 534 may alert the assistant device 532 that the package was delivered. The assistant device 532 may trigger an audio indicator 538 that a package has been delivered.

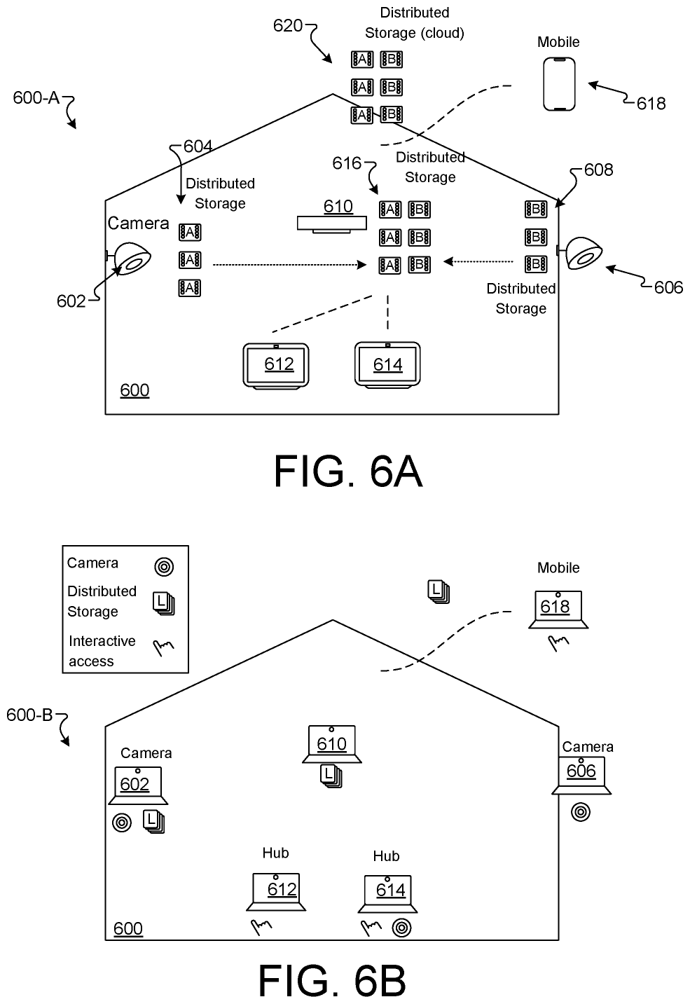

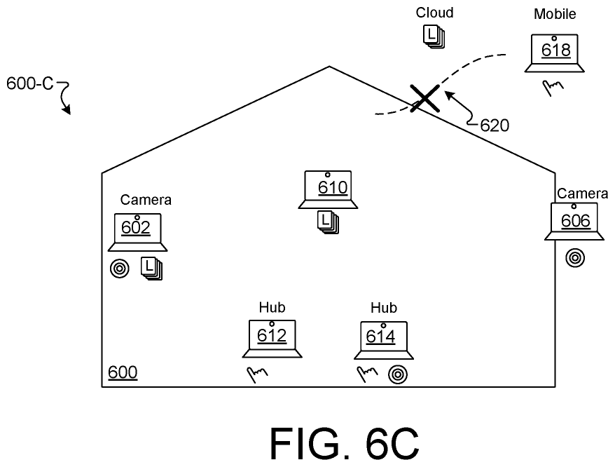

FIGS. 6A-6C illustrate example distributed ambient computing systems for a household, in accordance with implementations described herein. In the following examples, a distributed ambient computing system of household devices may be established. Each device capability may be determined. Each device location may also be determined. The distributed computing system may use security camera videos that have been captured by cameras. The captured videos may be stored in distributed storage, which may be synchronized across the devices associated with the location.

In this example, different capabilities are assigned to each device. The different capabilities in this example ay include camera input and recording capabilities, interactive access to contents capabilities, and storage capabilities. Each of the capabilities are build as a mode in a module that can be executed in any device.

As shown in FIG. 6A, a location 600 is defined. Location 600 includes location 600-A, 600-B, and 600-C, shown by different examples. Devices within the location 600 may be configured by system 200, for example, as part of a particular household associated with location 530, which may be used to generate a distributed ambient computing system. The location 530 may be or represent a user environment including, but not limited to a home, a household, a residence, a business, etc.

Devices shown in FIG. 6A at location 600-A include a camera 602 with a corresponding distributed storage 604, a camera device 606 with a corresponding distributed storage 608, an electronic device 610, an assistant device 612, and a second assistant device 614. The device 610, 612, and 614 may communicate with distributed storage 616. A mobile device 618 may be associated with location 600-A as well. In addition, each distributed storage 604, distributed storage 608, and distributed storage 616 may be synchronized with a network-based distributed storage 618 associated with the location 600.

Each device 602, 606, 610, 612, 614, and 618 may capture content with an onboard camera when the respective device detects unusual events. For example, local machine-based learning can be used to capture and upload, to distributed storage, images captured when such events are detected. In general, any device can execute a distributed storage log, for example, to store, date, and/or reference data in any of the storage 604, 608, 616, or 620, for example. Data may be asynchronously shared across the storage 604, 608, 616, or 620. Thus, each of the interactive devices 610, 612, 614, 618 may have access to the stored video/images.

Referring now to FIG. 6B, location 600-B is shown indicating cameras, distributed storage, and interactive access for each device detected within and/or configured for location 600. Here, the devices are shown as computing devices for simplicity. For example, camera 602 is associated with a camera functionality and a log functionality, but is not associated with interactive access functionality. Camera device 606 is shown with similar functionality to camera 602. Electronic device 610 includes log functionality, while devices 612 and 618 are shown with interactive functionality, but no log functionality. While devices 612 and 618 do not include log functionality, both devices may access distributed storage for other devices. Device 614 includes both interactive functionality and log functionality.

Referring now to FIG. 6C, the location 600-C is shown with the same devices 602, 606, 610, 612, 614, and 618. The location 600-C is shown in an offline mode, as indicated by an X 620 in which the Internet is not available or accessed by the devices. Here, the mobile device 618 may not have access to the devices, but the devices within the location 600-C may operate together and access locally stored log data regardless of being in an offline (or online) state.

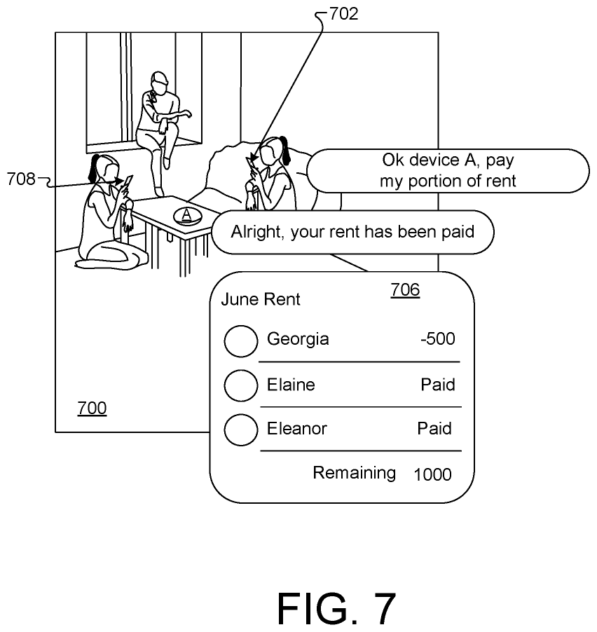

FIG. 7 is a diagram of an example of task execution carried out using ambient devices within a household, in accordance with implementations described herein. A location 700 is defined to include any number of devices located within range. Devices within the location 700 may be configured by system 200, for example, for any number of users as part of a particular household associated with location 700, which may be used to generate a distributed ambient computing system. The location 700 may be or represent a user environment including, but not limited to a home, a household, a residence, a business, etc. In this example, at least three users may share a home and may pay rent toward the home.

The location 700 may be a platform for associated users (e.g., members of the household) to share and/or split services, expenses, etc. For example, the location 700 may be configured as an identity that helps unite the household shared services (e.g., Wi-Fi, media, payments, etc.). In this example, users Georgia, Elain, and Eleanor are sharing services at the location 700 and may use the identity of the location 700 to associate devices with the location 700 and pay rent via their personal devices (or via other household devices).

At least one device (device A), may be associated with location 700. In this example, Georgia may generate a task (audible task) to request to pay her rent. The task may be presented to her mobile device 702. For example, Georgia may utter “Ok device A, pay my portion of rent.” In response, device A may communicate with Georgia's mobile device 702 to retrieve information for making the rent payment. Upon completion of the communication and rent payment, device A may respond verbally that the rent has been paid and/or may generate and send other indicators that Georgia's rent has been paid. For example, device A may generate an email and send the email to Georgia's email account, which may be retrieved by mobile device 702. In some implementations, device A in this example may also alert or otherwise indicate the paid rent to other users and/or devices associated with the location 700, as shown by indicator 706.

Other users associated with location 700 may also utilize services provided by device A (or another non-personal device within the location). For example, although Elaine has a mobile device 708, she may instead utilize device A to pay her portion of the rent if, for example, her mobile device were not yet configured as part of the distributed ambient computing system associated with the location 700.

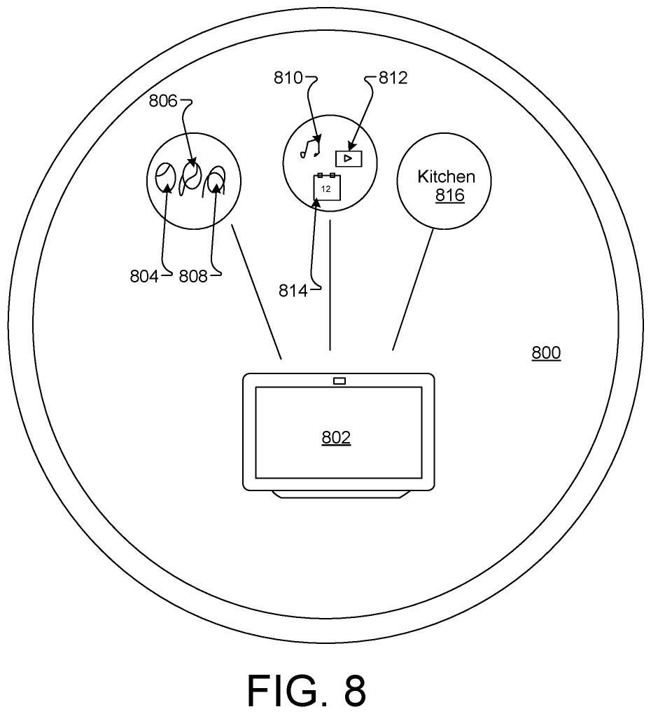

FIG. 8 illustrates provisioning of resources amongst ambient devices within a household, in accordance with implementations described herein. A location 800 is defined to include any number of devices located within range. Devices within the location 800 may be configured by system 200, for example, for any number of users as part of a particular household associated with location 800, which may be used to generate a distributed ambient computing system. The location 800 may be or represent a user environment including, but not limited to a home, a household, a residence, a business, etc.

In this example, a hub device 802 may represent a first device identity provisioned and/or configured for the household associated with location 800. The device 802 may be associated with or otherwise aware of the users of the household, but may not be tied to a user account provisioned by a service provider. The device 802 may instead be provisioned by the household, rather than specific user accounts, etc.

As shown, a first user 804, a second user 806, and a third user 808 are represented as part of the household at location 800. One or more of the users may pre-provision devices for particular purposes (e.g., functionalities 810, 812, and 814), rooms (e.g., kitchen 816), people (e.g., users 804, 806, and 808), and/or services (not shown). In some implementations, the devices may be part of the distributed ambient computing systems described herein, which may be used to manage one or more identities, concurrently.

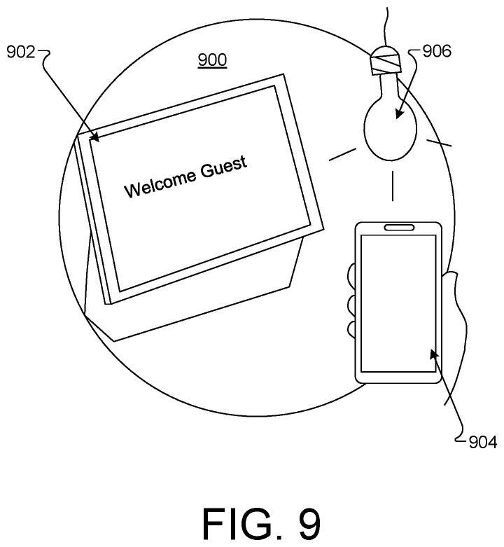

FIG. 9 illustrates providing modes within a household using ambient devices, in accordance with implementations described herein. A location 900 is defined to include any number of devices located within range. Devices within the location 900 may be configured by system 200, for example, for any number of users as part of a particular household associated with location 900, which may be used to generate a distributed ambient computing system. The location 900 may be or represent a user environment including, but not limited to a home, a household, a residence, a business, etc.

As shown in FIG. 9, a hub device 902 may welcome a guest in a guest mode. In a guest mode, the household may host visitors to the location 900 without having to provide home instruction manuals, passwords, and the like. Instead, because location 900 may be associated with a distributed ambient computing system, the system may offer guests particular device use, services and/or connections that the user previously provisioned for the guest mode. For example, users may provide Wi-Fi network enablement on a guest mobile device 904, but may alert other devices in the household of connection to such a network in case a particular connected device is unrecognized. Similarly, the device 902 may provision access and control of lighting devices 906 via guest mobile device 904. Privacy of the household may be protected since personal household data is either not sent to a guest device or is instead hidden from the guest device while still providing the service and/or device usage to the guest device.

In some implementations, the location 900 may use context to hide personal data from guests. Such context may trigger the privacy mode. The privacy mode may include dynamic authentication allowing for concurrent and sequential multi-user usage of the services and/or devices at location 900. In addition, the privacy mode may be provided for particular users, which can be managed in real time based on device placement and presence. For example, devices in a bedroom may trigger a privacy mode during scheduled meetings, household visits, or when users are not home, while devices in a dining area may trigger a different privacy mode obscuring some data, but not each portion of the data. The privacy mode may also be managed by presence, relationships and activities occurring at the location 900.

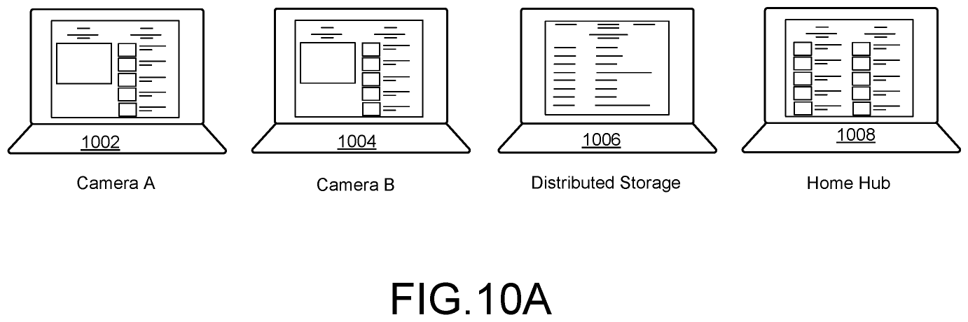

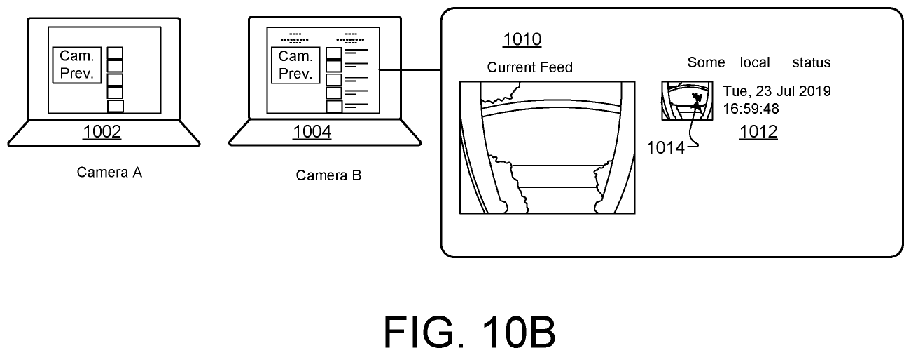

FIG. 10A illustrates an example of task handling using multiple ambient devices and a distributed storage 1006, in accordance with implementations described herein. As shown in FIG. 10A, a distributed ambient computing system for an example home includes a camera device A 1002, a camera device B 1004, the distributed storage 1006, and a hub device 1008. Device capabilities may be transferred amongst devices. For example, distributed storage may provide log capabilities which may be transferred from distributed storage 1006 to hub device 1008. The hub device 1008 is the only interactive device depicted. Each of the devices 1002, 1004, 1006, and 1008 is usable in an online mode. That is, the home is connected to an Internet service.

Referring to FIG. 10B, the camera device A 1002 and the camera device 1004 are again depicted. Here, camera device B may capture a video and/or images if activity is detected. For example, at a first time 1010 representing the current camera B feed, the camera input shows that no activity is detected. On Tuesday at time 1012 (e.g., 16:49:48), movement (e.g., dog 1014) is detected and a snapshot and/or video is stored in the local ledger (e.g., distributed storage). In general, devices associated with the distributed ambient computing system may gain access to images and/or video by accessing the distributed storage 1006. In addition, devices within the distributed ambient computing system may immediately view changes to the distributed storage 1006 and may review content from the distributed storage 1006 at a later time.

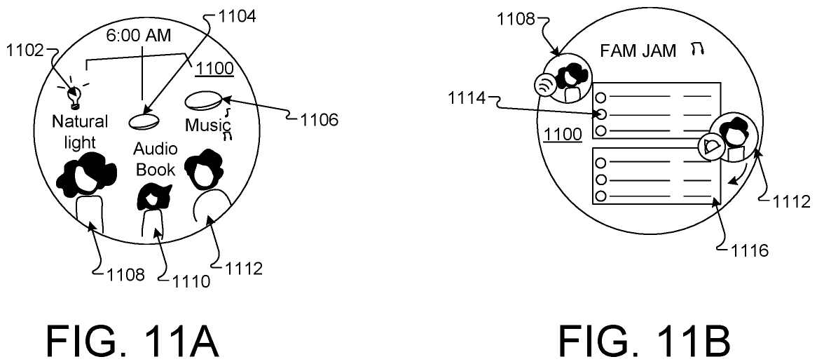

FIG. 11A illustrates examples of orchestrating activities and resources within a household using ambient devices, in accordance with implementations described herein. As shown in FIG. 11A, a distributed ambient computing system for an example home location 1100. The location 1100 includes a light device 1102, a first audio device 1104, and a second audio device 1106, each device being respectively accessed by user 1108, user 1110, and user 1112.

The example household devices may be part of the distributed ambient computing system that may be generated for location 1100. The users 1108, 1110, and 1112 may represent a family with schedules, personal devices, tasks, etc. The distributed ambient computing system may be used to orchestrate activities across devices, identities, and personal preferences in the family. In some implementations, the system 200, for example may be used to combine the family owned photographs, video collections, notes, social media, alarms, calendars, etc., into a single bulletin board display such that users in the family may easily access other user schedules and information. The system 200 may sense particular patterns occurring within the household throughout the day and may provides suggestions to streamline or improve such patterns. The systems and methods described herein may provide such suggestions and shared user data while ensuring that personal data remains within the home. For example, home data and user data is not provided outside of the home devices unless the information is encrypted and cannot be linked to personal user accounts owned by typical account service providers. In addition, product usage, data usage, and time-based or contextual usage of such products or data may not be distributed outside of the home.

The systems within the distributed ambient computing system ensure that such information is not gathered by other parties outside of the home systems. Thus, users may have multi-device journeys throughout the day where data does not leave the home systems. For example, the user 1108 may set an alarm for device 1104 using device 1106 while the devices are offline. The system 200 may utilize distributed storage 256, which may communicate with devices in the home using peer-to-peer communications, private communications, using offline modes. The distributed storage may retrieve data stored from a particular device and may synchronize such data across household devices. In some implementations, a decentralized peer-to-peer computer network may be used for particular communications, transfers, and/or device synchronizations.

Referring to FIG. 11B, the user 1108 may share her playlist 1114 with the household devices. Similarly, user 1112 may share her playlist 1116 with household devices. For example, the distributed ambient computing system 200 set up amongst devices 1102, 1104 and 1106 (and other household devices) may use shared household group services and preferences to play music for the family. The sharing of content may ensure home-centric services are tied to the household. Personal devices may inherit aspects of the household devices without having to configure the personal devices with other accounts, for example.

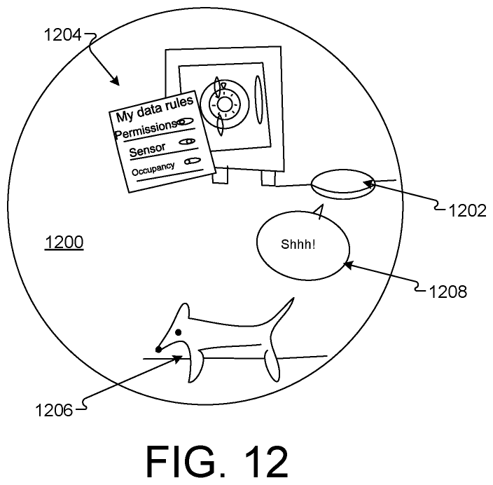

FIG. 12 illustrates an example of orchestrating activities and sharing resources with devices associated with a household, in accordance with implementations described herein. A location 1200 is defined to include any number of devices located within range. Devices within the location 1200 may be configured by system 200, for example, for any number of users as part of a particular household associated with location 1200, which may be used to generate a distributed ambient computing system. The location 1200 may be or represent a user environment including, but not limited to a home, a household, a residence, a business, etc. In this example, the location 1200 includes at least one device 1202. The device 1202 may utilize architecture 300 and 350 to ensure that data rules 1204 are implemented for location 1200 and devices associated with location 1200. For example, data rules 1204 may include or govern user data 228, user preferences 254, user policies 252, and other content handled by the identity manager 220, the device manager 22, the task manager 218, and the context manager 224. In general, data rules 1204 may be secured and toggled via permissions, sensor triggers, occupancy triggers, etc. In particular, the users associated with location 1200 may have visibility and control over household related data and user data using data rules 1204.

In some implementations, a user may configure a data rule 1204 to allow a camera device (not shown) to operate in particular rooms of the home. For example, the data rule 1204 may indicate to capture video of a pet 1206 to provide a safety check of the pet 1206. If the camera device (not shown) is set to capture movement in the room housing the camera device, the data rule may be configured to capture movement above a predefined latitude (e.g., level from a floor of the room) to, for example, capture the pet 1206 while barking, etc. This may allow a family member to witness the barking behavior at a later time. Additionally, the capture of the movement may trigger other devices to announce particular events or information to a user in another room, based on user permissions and or user-configured policies and/or rules. As shown, device 1202 has been notified that the data rule of movement above the predefined latitude has been met and as such, an announcement 1208 of “Shhh!” is indicated from device 1202 to the user in the other room with device 1202, for example.

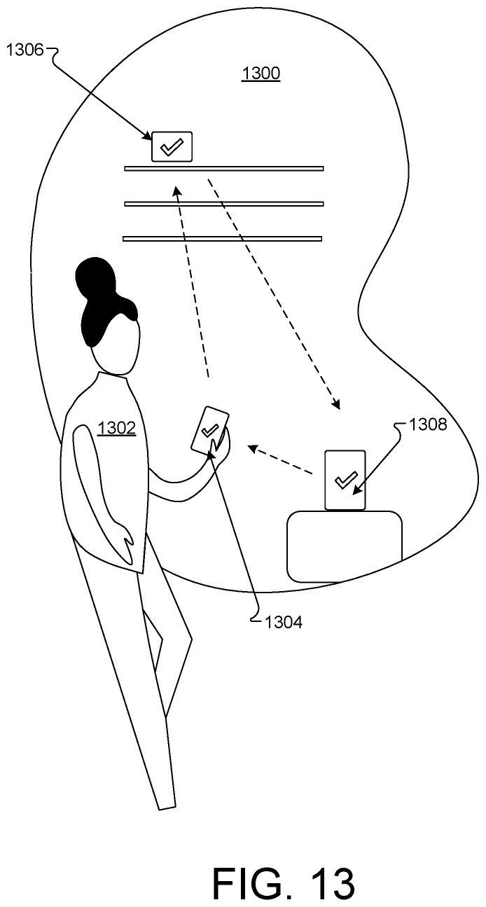

FIG. 13 is a diagram illustrating an ambient device sharing policies with other ambient devices associated with a household, in accordance with implementations described herein. A location 1300 is defined to include any number of devices located within range. Devices within the location 1300 may be configured by system 200, for example, for any number of users as part of a particular household associated with location 1300, which may be used to generate a distributed ambient computing system. The location 1300 may be or represent a user environment including, but not limited to a home, a household, a residence, a business, etc.

In conventional device configurations, each device is set up in a set of steps that force the user to execute a workflow of device setup. This may be cumbersome to perform for each additional device, each of which may be a different and unique workflow to properly configure the respective devices. The system 200 may be used to set up a distributed ambient computing system (e.g., network of devices) which may use minimal user effort. The system 200 may perform the setup flows for each device by leveraging the knowledge of device capabilities and other devices and information previously associated with the system 200.

In some implementations, device setup for the home for a location (e.g., location 1300) may be automated based on a previous device setup and user permissions. For example, a user 1302 may have previously configured mobile device 1304. The system 200 may sense when a new device 1306 has been brought into the home of location 1300, for example, and may ask the user for permission to set the new device up for them instantly. Such a workflow may remove, for the user, the burden of managing devices. The more devices the user adds, the more information the system may learn to improve user experiences. For example, upon configuring device 1304 and providing the configuration of device 1304 to configure device 1306, the system 200 may detect when a third device (e.g., device 1308) is available for the location 1300. The system 200 may then transfer data amongst device 1304 and device 1306 to properly configure device 1308 for use in the distributed ambient computing network of location 1300. The user data does not leave the home at location 1300 unless it is user requested to be moved and in such cases, the user data is encrypted and cannot be linked to a personal user account in the home by other parties (e.g., other users, service providers, account providers, etc.). This may provide an advantage of ensuring that the distributed ambient computing network for a particular location will provide users with confidence on how their data is handled. In addition, such data rules may enable devices from different manufacturers to be configured to work together under one household.

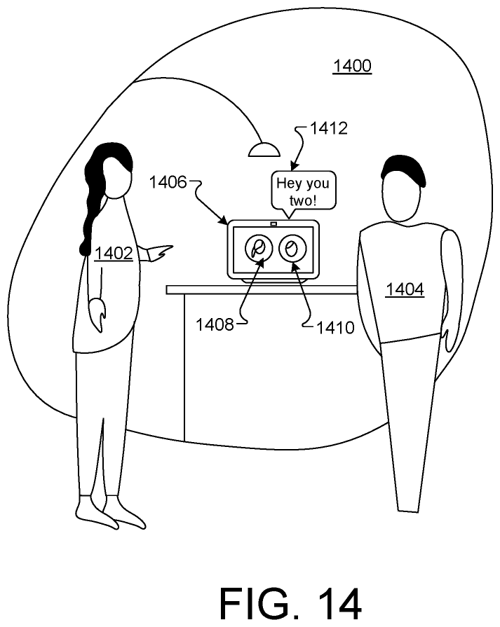

FIG. 14 is a diagram illustrating an ambient device recognition of at least two users, in accordance with implementations described herein. A location 1400 is defined to include any number of devices located within range. Devices within the location 1400 may be configured by system 200, for example, for any number of users as part of a particular household associated with location 1400, which may be used to generate a distributed ambient computing system. The location 1400 may be or represent a user environment including, but not limited to a home, a household, a residence, a business, etc.

As shown in FIG. 14, a first user 1402 and a second user 1404 are part of a distributed ambient computing system set up for location 1400. An assistant/hub device 1406 is configured as part of the system for location 1400 as well.

In conventional systems, device experiences may be optimized for whomever configured the device. For example, conventional device configurations are tied to users with user accounts, which are tied to service providers. Secondary users (e.g., users that did not configure the device) are typically inadequately considered, which may lead to a lack of a personalized experience for the second user. The system 200 may ensure that additional users of the household are considered and provided for with respect to household devices associated with location 1400. For example, the system 200 may understand a communal context while respecting individual preferences. Experiences provided from devices associated with system 200 (and location 1400) may be family and communally-oriented, and still offer personal value to each user. In the depicted device 1406, both users 1402 and 1404 are recognized (shown by icon 1408 and icon 1410, respectively). The device 1406 may address both users, as shown by audio indicate 1412

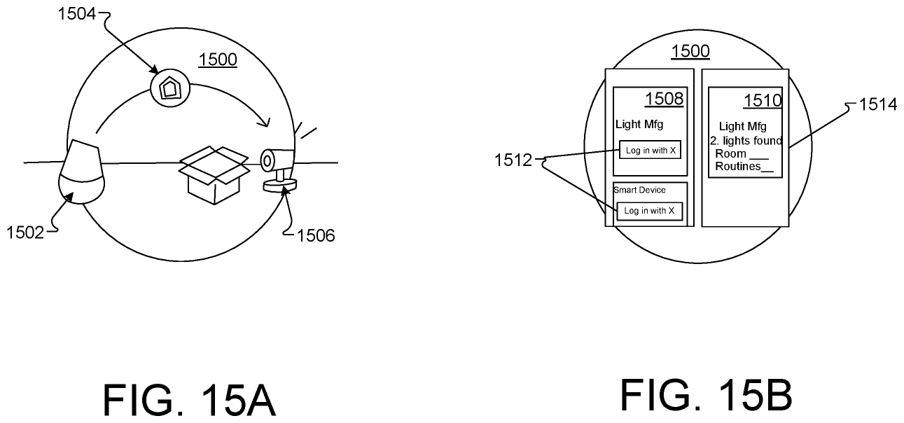

FIGS. 15A-15B illustrate example ambient device configuration for a household, in accordance with implementations described herein. A location 1500 is defined to include any number of devices located within range. Devices within the location 1500 may be configured by system 200, for example, for any number of users as part of a particular household associated with location 1500, which may be used to generate a distributed ambient computing system. The location 1500 may be or represent a user environment including, but not limited to a home, a household, a residence, a business, etc.

Referring to FIG. 15A, an assistant device 1502 is shown as part of a home account 1504 that may have been previously configured for the location 1500. Here, device 1506 may be newly added. The home account 1504 may use a system 200 which may have device-to-device awareness for utilizing one or more devices within location 1500 to recognize particular devices and/or capabilities and may trigger such new devices to inherit particular credentials and/or preferences.

Referring to FIG. 15B, the device 202 may also provide a module out of the box experience. For example, device configuration and service configurations may be implemented as separate modules that can individually activated and reordered depending on the particular device (or service) that a user is configuring. The modules may represent embeddable and branded components that can be added to particular device software.

In addition, information associated with a home account 1504 (e.g., device distributed storage) may be used to set up devices within the location 1500. For example, system 200 may use the home account 1504 to recognize a first device manufacturer 1508 and a second device manufacturer 1510. In this example, the first device manufacturer may be a light bulb manufacturer, while the second device manufacturer may be a smart outlet manufacturer. Here, the system 200 may allow the user to log into the devices via the particular manufacturer or service provider via a device associated with the distributed ambient computing system, as shown by elements 1512. In some implementations, the system 200 may detect particular devices, as shown by indicator 1514. System 200 detected that two lights were found and may indicate which rooms and routines are configured for the two lights. System 200 may also provide indicators similar to indicator 1514 to allow the user to configure particular routines and rooms or to configure inheritance of other routines from other devices.

In some implementations, the system 200 may detect particular product keys associated with devices. As the product keys are recognized, the system 200 can provide naming and language elements associated with the home location 1500. Nearby sensor devices can serve as a hub for communication and processing for device setup and task management amongst devices, for example. An original equipment manufacturer may include embeddable, branded components that users can enable based on permissions without visually leaving a device configuration flow, for example.

In some implementations, the system 200 may trigger configuration of additional devices that a user brings into the location 1500. For example, system 200 may discover new devices near the already configured distributed ambient computing system and may begin to provision the new device into the system. In addition, system 200 may register the new device by storing device information in distributed storage associated with the location 1500. The system 200 may provide user and/or device preferences from any other device associated with location 1500 to the new device. Accounts and/or services may then be linked amongst the devices including the new device.

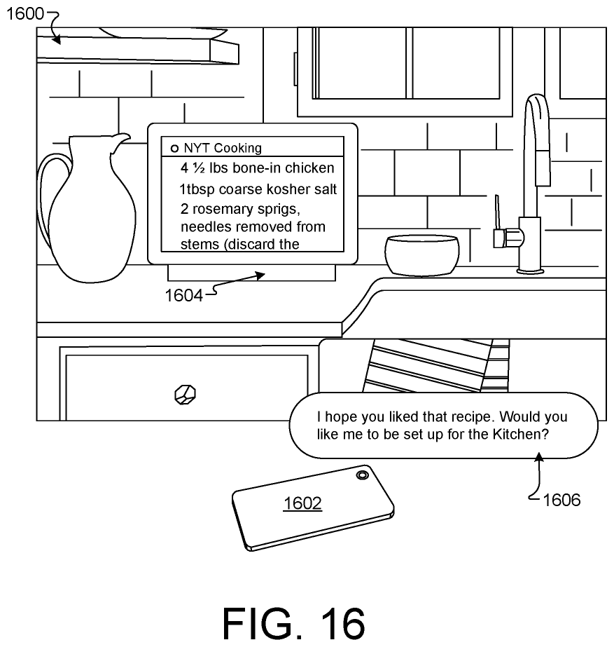

FIG. 16 is a diagram illustrating another example of ambient device configuration for a household, in accordance with implementations described herein. A location 1600 is defined to include any number of devices located within range. Devices within the location 1600 may be configured by system 200, for example, for any number of users as part of a particular household associated with location 1600, which may be used to generate a distributed ambient computing system. The location 1600 may be or represent a user environment including, but not limited to a home, a household, a residence, a business, etc.

In this example, a user may typically access mobile device 1602 for recipes. At some point, the user may purchase another device 1604 for location 1600. The user may remove the device 1604 and place the device within the home associated with location 1600. The system 200 may detect the device 1604 and may detect capabilities associated with the device 1604. At some point, the device 1604 may recognize a household need (e.g., a task that a user may benefit from). In the depicted example, device 1604 recognized via system 200 that device 1604 may be useful for providing recipes in the kitchen, as shown by indicator 1606. Here, system 200 may determine that providing recipe instructions via device 1604 may be useful, and in response, triggered a portion of a configuration for viewing recipe applications (e.g., previously accessed on device 1602) for receiving instructions via device 1604. In some implementations, additional functionality may be available on device 1604 without a user having to configure the functionality based on information retrieved via the distributed ambient computing system 200.

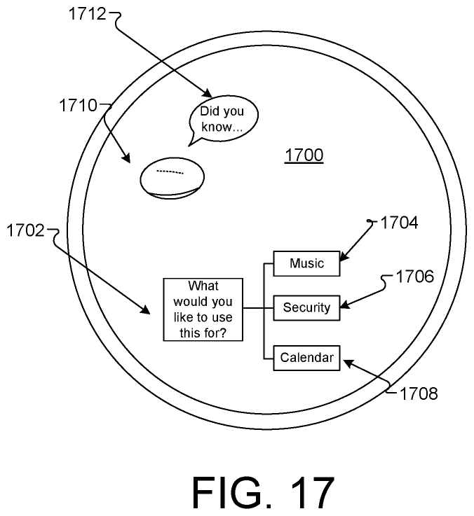

FIG. 17 illustrates another example of ambient device configuration for a household, in accordance with implementations described herein. A location 1700 is defined to include any number of devices located within range. Devices within the location 1700 may be configured by system 200, for example, for any number of users as part of a particular household associated with location 1700, which may be used to generate a distributed ambient computing system. The location 1700 may be or represent a user environment including, but not limited to a home, a household, a residence, a business, etc.

In some implementations, ambient device configuration may provide configuration options that are experiential and proactive by surfacing questions, services, and other options for configuring devices for a household. For example, an example configuration option may determine a context and/or user interest to set up a device. One example is shown in FIG. 17 by a question indicator 1702 which asks the user “What would you like to use this device for?” Such a question may also provide answers that the user may select, as shown by answers 1704, 1706, and 1708.

The system 200 may also provide continuous discovery modules (e.g., options) after device configuration (and over time) to enable discovery and configuration of new features and/or services. For example, device 1710 indicates a “did you know” audio question 1712 to enable the user to learn about new or unconfigured features and/or services. Particular configuration modules may be surfaced contextually over time.

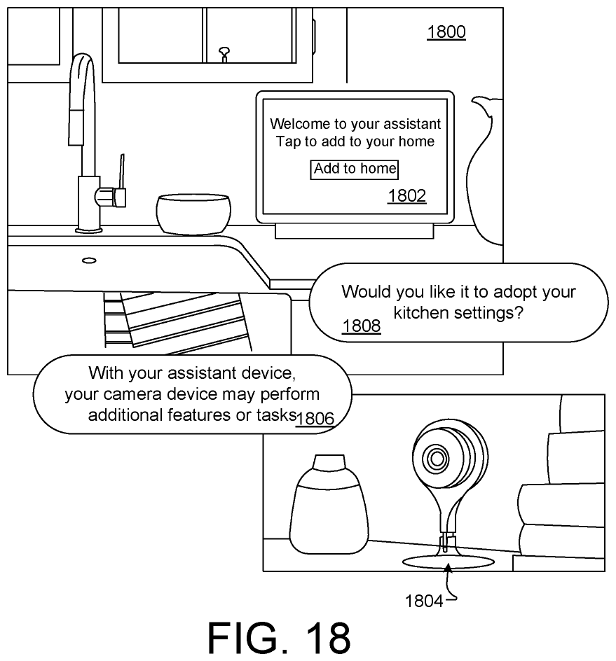

FIG. 18 is a diagram illustrating an example of an ambient device sharing policies and configuration details with other ambient devices associated with a household, in accordance with implementations described herein. A location 1800 is defined to include any number of devices located within range. Devices within the location 1800 may be configured by system 200, for example, for any number of users as part of a particular household associated with location 1800, which may be used to generate a distributed ambient computing system. The location 1800 may be or represent a user environment including, but not limited to a home, a household, a residence, a business, etc.

As shown, an assistant device 1802 may be utilized with a camera device 1804. When the assistant device 1802 is brought into location 1800, the household system (e.g., system 200) may provide indications such as indicator 1806 that the camera device 1804 capabilities may be upgraded to additional features or tasks when used with the assistant device 1802. Such upgrades may be user-enabled, user-disabled, and/or permission based. In another example, questions may be provided to the user when a new device is brought into location 1800, such as questions regarding setting up particular devices as part of settings associated with a room, as shown by indicator 1808. In general, room-wide and home-wide polices and capabilities that are associated with the location 1800 may be adopted by new products and/or services. Thus, new devices and services may be seamlessly and in some cases device-requested to be triggered for addition to the home systems. In some implementations, when a user moves a device between particular rooms, the moved device may adopt the settings, preferences, and/or behaviors associated with the new room.

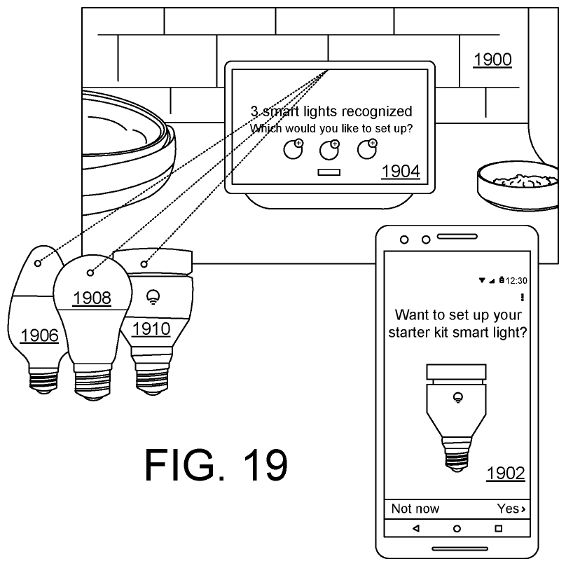

FIG. 19 is a diagram illustrating an example of configuring third party sensors for a household, in accordance with implementations described herein. A location 1900 is defined to include any number of devices located within range. Devices within the location 1900 may be configured by system 200, for example, for any number of users as part of a particular household associated with location 1900, which may be used to generate a distributed ambient computing system. The location 1900 may be or represent a user environment including, but not limited to a home, a household, a residence, a business, etc.

A user may have a mobile device 1902 configured with location 1900. The mobile device may be used to configure additional devices associated with location 1900. However, if the user chooses not to set up the additional devices, the devices may be autodetected at a later time by another device. For example, assistant/hub device 1904 may detect the new devices (e.g., smart light bulb device 1906, smart light bulb device 1908, and smart light bulb device 1910). The hub may generate a suggestion for a user with indications, questions, and/or other guidance. Here, smart light bulb 1906, smart light bulb device 1908, and smart light bulb device 1910 are each from a third party (3P) manufacturer that are not correlated or associated with devices 1902 or 1904, each manufactured by one or more different manufacturers than of the smart light bulb devices 1906-1910. However, device 1904 may be associated with a system 200 in which underlying operating system software may provide access to additional setup APIs and/or pairing standards to seamlessly embed configuration of smart bulb devices 1906-1910 into configuration for the home associated with location 1500. As such, the ecosystem generated by system 200 (e.g., a distributed ambient computing system) may be consistent across devices while allowing devices 1906-1910 to retain and express their underlying brand.

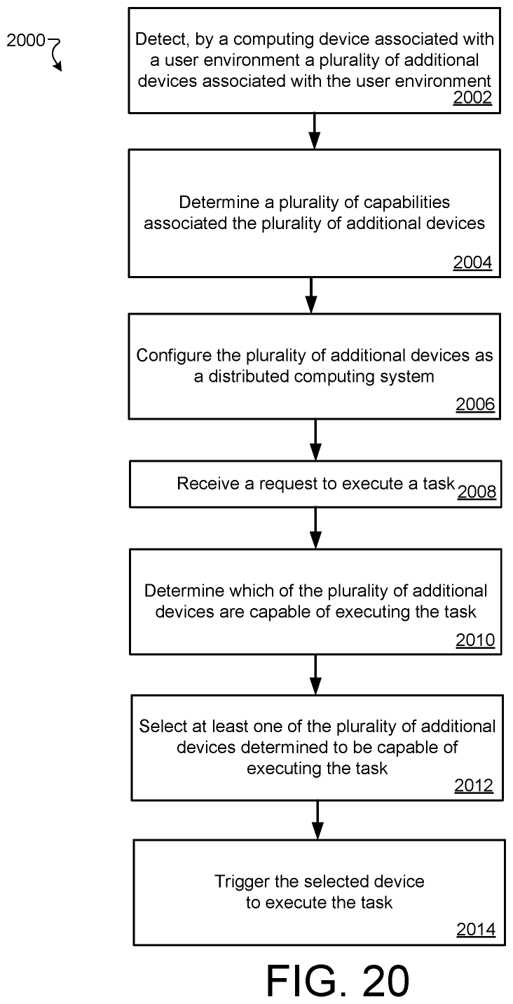

FIG. 20 is an example process 2000 of operating a distributed ambient computing system, in accordance with implementations described herein. The process 2000 may ensure that devices in a defined user environment may communicate, share and execute tasks. The process 2000 may be described with reference to system 200, architectures 300 and 350, for convenience.

At block 2002, the process 2000 includes detecting, by a computing device, a plurality of additional devices associated with a user environment. For example, computing system 202 may detect any number of devices 104, 106, 108, 112, 114, 116, and 204 within a location defined as a user environment, such as a location (e.g., household/home). The detection may include detection of existence of the devices, a location associated with each of the respective devices, a proximity between devices in the user environment, etc. In general, the additional devices may or may not include personal user devices, such as mobile phones, laptops, desktops, etc.

At block 2004, the process 2000 includes determining, for the plurality of additional devices, a plurality of capabilities associated with one or more of the plurality of additional devices. For example, system 202 may determine device capabilities and/or processing capabilities associated with each of the devices 104, 106, 108, 112, 114, 116, and 204. Example capabilities may include, but are not limited to, device sensor capabilities, device communication capabilities, device processing capabilities, device hardware capabilities and/or device software capabilities, just to name a few examples. In some implementations, computing system 202 may access one or more distributed storage logs associated with devices within a particular household location to assess and/or determine capabilities.

At block 2006, the process 2000 includes configuring, by the computing device, the plurality of additional devices as a distributed computing system. The plurality of additional devices may be defined in the distributed ambient computing system according to at least one of the plurality of capabilities and a device location within the user environment. For example, the computing system 202 can assess that each of the devices 104, 106, 108, 112, 114, 116, and 204 may be associated with (and/or within a particular distance of a location of) a household of users. In response, the system 202 may generate and/or otherwise configure devices 104, 106, 108, 112, 114, 116, and 204 to operate as a distributed ambient computing system capable of executing tasks for the household.

In some implementations, configuring the plurality of additional devices as a distributed computing system includes enabling, for the plurality of additional devices, policies and user preferences associated with the user environment and the computing device. For example, the computing system 202 may review the plurality of capabilities associated with each device to determine which, if any policies can be enabled on particular devices. For example, if two devices are in bedroom locations within the home, the computing system 202 can enable a predefined policy that camera devices within such areas are turned off unless a device user configures a different policy associated with such areas. In some implementations, configuring the plurality of additional devices as a distributed computing system may include performing a security check on the unidentified device in response to detecting an unidentified device within the user environment. The configuration may also include configuring the policies and user preferences on the unidentified device if the unidentified device passes the security check.

At block 2008, the process 2000 includes receiving, at the computing device, a request to execute a task. For example, the computing system 202 may receive a request to execute a task from device 106. The task may include watch the front door between 2:00 PM and 4:00 PM on Monday to make sure Ella returns from school. In this example, the system 202 may receive the request and begin to determine how to execute the task.

At block 2010, the process 2000 includes determining, by the computing device, which of the plurality of additional devices are capable of executing the task. For example, computing system 202 may determine which of the devices associated with the household (e.g., devices 104, 106, 108, 112, 114, 116, and 204) can perform the task.

At block 2012, the process 2000 includes selecting at least one of the plurality of additional devices determined to be capable of executing the task. The selection of the additional devices may be based at least in part on a determined proximity of the plurality of devices to the computing device. For example, computing system 202 may determine which devices are proximate to the computing device receiving the requested task to first determine whether or not the task (or user) would benefit from being carried out by a device near the user and/or near the task receiving device 202, for example. In this example, the task involves watching a particular location, so the proximity may not be considered when selecting one or more devices to carry out the task.

In some implementations, the computing system 202 may select one or more of the plurality of additional devices by assessing a determined operating system executing on a respective device in the plurality of devices. For example, particular devices in the system 200 may include an operating system associated with a flag or indicator that indicates that the device is capable of performing particular tasks or capable of sharing or distributing tasks amongst other devices. In some implementations, the devices may include a module that determines a device operating system and then determines whether the device operating system is capable of performing particular tasks or distribution of such tasks. In some implementations, the operating system of particular devices in system 200 may notify other devices in system 200 of available device capabilities and/or protocols to be used with the particular device.

For example, if particular camera footage of a device is user-configured to be transmitted to a user not at the location of the home or using a device not configured for the home, then the system 202 may have to select another device that is enabled to transmit content to offsite devices or non-approved devices. For example, the distributed ambient computing system 200 may have particular devices that may transmit information to offsite users upon request according to a system policy. Such a policy may be configured for devices that capture different types of data. For example, content and/or data captured by a doorbell camera or an outdoor security camera may be less likely to include user data and thus a policy may be configured to remotely access such data without the household encryption or other security protocols associated with system 200.

In some implementations, the computing system 202 may select one or more of the plurality of additional devices by assessing determined sensor-based capabilities available on a respective device in the plurality of devices. Sensor-based capabilities may include device capabilities that operate and/or otherwise use a device sensor to perform the capabilities. For example, the system 202 may determine which of the devices in system 200 include cameras and/or other image capturing (using image sensors) capabilities. Such devices may be selected and ranked according to the location associated with the respective device. For example, the doorbell camera (not shown) and the security device 106 may be selected for executing the task, but the security device 106 may be selected based on capturing the street view and home entrance of the child (e.g., Ella) arriving and entering the home. Other devices may also be selected and ranked based on facial recognition capabilities when Ella enters the home, for example.

In some implementations, selecting of the at least one of the plurality of additional devices is further based on detected information associated with the user environment. For example, the user environment may be defined as a physical building containing the computing system 202 and the plurality of additional devices 104, 106, 108, 112, 114, 116, and 204. Each device may include additional useful information that may help execute the task.

In some implementations, selecting the at least one of the plurality of additional devices to execute the task includes determining a context for the user environment. The context may be based on detected information and stored information associated with one or more of the plurality of additional devices. For example, the detected information includes calendar information. For example, a calendar on assistant device 112 may detect that Ella is not in school on Monday based on a recently scheduled practice. Accordingly, if the task is a recurrent task that occurs every Monday and the scheduled school outage is an anomaly, the system 202 may detect the event that includes Ella and may send a notification to the task requester to let the requester know that Ella is not expected to be home between the requested watch time.

Other detected data regarding the requested task is of course possible. For example, in some implementations, the detected information corresponds to a detected user activity level in the user environment which may, for example indicate that Ella is already in the home (or arrived early). In some implementations, the detected information may correspond to one or more detected audio requests or detected visual imagery in the user environment. For example, if Ella submitted an audio request at 1:45 PM or is captured by one of the device cameras of the household, the task may be removed and/or otherwise rescheduled. Communications may be sent to the task requester using the detected audio and/or visual imagery.

In some implementations, the process 2000 may include selecting, by the computing system 202, a second device in the plurality of additional devices to generate output corresponding to the task. For example, once Ella arrives home, an indoor captured photo of Ella may be provided to the task requester to indicate that Ella arrived home and the captured photo may provide proof of Ella being home.

In some implementations, the selection of the second device may be based at least in part on determining that the selected at least one of the plurality of additional devices (e.g., the security device 106) is unsuited to generate and communicate output corresponding to the task. For example, although device 106 may send a capture of Ella at the front door of the home, device 106 may not be capable of capturing an indoor photo of Ella showing that Ella has indeed entered the home. Instead, device 110 may detect the presence of Ella and may capture and send a photo of Ella to the task requester.

In some implementations, selecting, by the computing system 202, a second device of the plurality of additional devices to generate output corresponding to the task may include selection of the second device based at least in part on determining that the location of the security device 106 is out of a predefined visual range or predefined audio range of a user associated with the request to execute the task. For example, if a task request includes carrying out a task in a room than device 106, a different device may be selected to execute the task, such as device 110.

At block 2014, the process 2000 includes triggering, by the computing device, the selected device to execute the task. For example, the computing system 202 may trigger execution of capturing images of any movement within range of security device 106 between the hours of 2:00 and 4:00. In some implementations, triggering, by the computing system 202, the selected device (e.g., security device 106) to execute the task includes accessing, via an operating system associated with the computing system 202, at least one service in communication with the respective operating system executing on the selected at least one additional device (e.g., security device 106). For example, the security device 106 may not be capable of sending images and/or content to other devices. A service may be configured using one or more device distributed storage (e.g., logs), for example, to transfer captured content to devices within system 200 that may generate communication messages to other devices within the home or to devices approved to receive home content (e.g., a mobile device of a household member that requested the task). Such a service may be configured to dispatch the received task to at least one other device in the plurality of additional devices. For example, device 106 may capture the photo of Ella and may send (or make available) the photo to assistant device 114 which is configured via the underlying onboard operating system to generate and send messages to other onsite or remote household devices.

In some implementations, triggering the selected device (e.g., device 106 and/or device 114) to execute the task includes generating visual output (e.g., the photograph of Ella), the visual output provided on the display of the computing device, in response to determining that the computing device is within a threshold distance to a user associated with the received request to execute the task.

In some implementations, triggering the selected device to execute the task includes generating visual and audio output (e.g., captured images, captured video, etc. from security device 106). The visual and audio output may be provided on another of the plurality of additional devices in response to determining a time of day outside of a predefined time period. For example, if the system 200 does not approve sending household data to devices outside the home, the information may be sent or logged to another device within the system 200. The other device may be approved to send such data and may alert the task requester about the arrival of Ella, for example. In some implementations, the system 202 may trigger display of a graphical control element on the display of the computing device (or any device associated with system 200) to enable user selected control for the device selected to execute the task. An example control may be a play button to play a video associated with the task, for example.

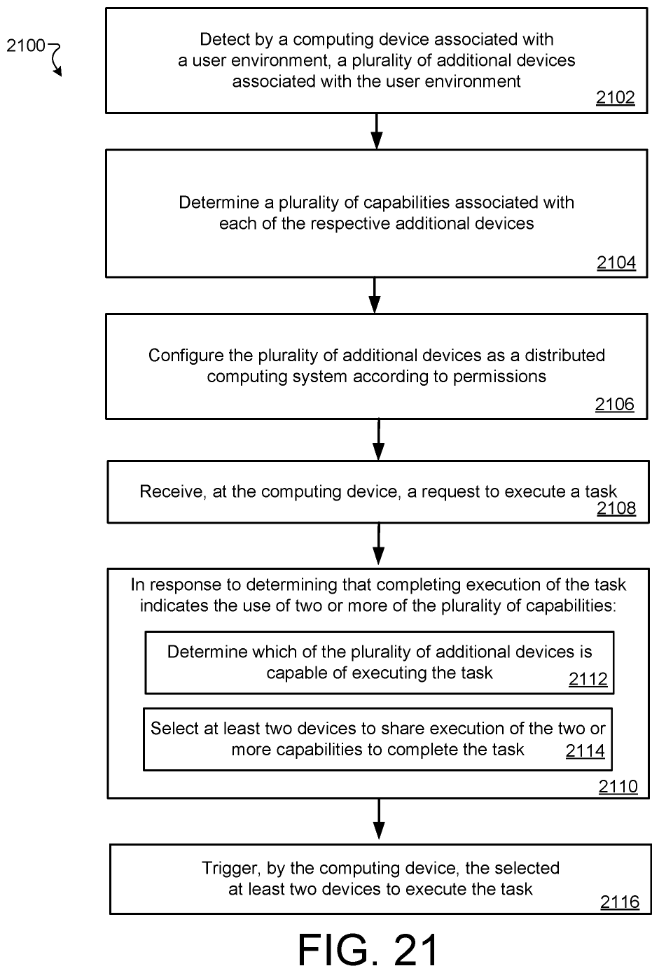

FIG. 21 is an example process 2100 of operating a distributed ambient computing system to share tasks amongst multiple devices, in accordance with implementations described herein. The process 2100 may ensure that devices in a defined user environment may communicate, share, and execute tasks. The process 2100 may be described with reference to system 200, architectures 300 and 350, for convenience. In some implementations, devices described throughout this disclosure may operate as other devices within system 200. For example, assistant device 114 may operate as computing system 202 including each component of device 202.

At block 2102, the process 2100 includes detecting, by a computing device, a plurality of additional devices associated with a user environment. For example, computing system 202 may detect any number of devices 104, 106, 108, 112, 114, 116, and 204 within a location defined as a user environment, such as a location (e.g., household/home). The detection may include detection of existence of the devices, a location associated with each of the respective devices, a proximity between devices in the user environment, etc. In general, the additional devices may or may not include personal user devices, such as mobile phones, laptops, desktops, etc.

At block 2104, the process 2100 includes determining, for the plurality of additional devices, a plurality of capabilities associated with each of the respective additional devices. For example, system 202 may determine device capabilities and/or processing capabilities associated with each of the devices 104, 106, 108, 112, 114, 116, and 204. Example capabilities may include, but are not limited to, device sensor capabilities, device communication capabilities, device processing capabilities, device hardware capabilities and/or device software capabilities, just to name a few examples. In some implementations, computing system 202 may access one or more device distributed storage or storage, in general, associated with devices within a particular household location to assess and/or determine capabilities.

At block 2106, the process 2100 includes configuring, by the computing device, the plurality of additional devices as a distributed computing system, the plurality of additional devices corresponding at least one of the plurality of capabilities and a device location within the user environment. In some implementations, the distributed computing system may be configured according to user-configured permissions, user consent, and or other device-based policies.

The plurality of additional devices may be defined in the distributed ambient computing system 200 according to at least one of the plurality of capabilities and a device location within the user environment. For example, the computing system 202 can assess that each of the devices 104, 106, 108, 112, 114, 116, and 204 may be associated with (and/or within a particular distance of a location of) a household of users. In response, the system 202 may generate and/or otherwise configure devices 104, 106, 108, 112, 114, 116, and 204 to operate as a distributed ambient computing system capable of executing tasks for the household.

At block 2108, the process 2100 includes receiving, at the computing device, a request to execute a task. For example, the user 102 may be exiting the home and may wish to engage security measures. As shown in FIG. 1A, the user may utter or otherwise request performance of a task 118 (i.e., protect my house) to trigger device 114, for example, to organize the uttered task 118 amongst one or more of ambient devices 104-116. The computing system 202 may, for example, be included in assistant device 114 or device 116 that may be executing an O/S capable of interpreting commands to and from the platform described herein.

At block 2110, the process 2100 includes determining that completing execution of the task indicates the use of two or more of the plurality of capabilities. For example, the assistant device 114 (operating as device 202) may determine, within the distributed computing system 200, which of the plurality of additional devices is capable of executing the task (block 2112) and select at least two devices, in the plurality of additional devices, to share execution of the two or more capabilities to complete the task. The selecting of the at least two devices may be based at least in part on a determined proximity of the two devices to the computing device (block 2114).

For example, upon receiving the task 118, device 114 may assess which devices in the system are capable of protection measures (e.g., security tasks). The device 114 may also determine particular proximities for devices, which may be used to assess which devices to engage security measures upon. The device 114 may turn on security features for the devices determined to have security capabilities and that follow the policy for the home, for example. Here, the device 114 (operating as device 202) may determine that the door lock device 104 and the security device 106 suffices for protecting the home.

In operation, device 114 may send signals and log such signals in the distributed storage, to trigger devices 104, 106, 108, 110, 112, and 116 to carry out security engagement for the home. Each engaged device may also log the signals in a respective distributed storage associated with each respective device. Each distributed storage (e.g., log) may synchronize to a master household distributed storage (e.g., distributed storage 257) such that decisions may be made using the master household ledger (e.g., distributed storage).

At block 2116, the process 2100 includes triggering, by the computing device, the selected at least two devices to execute the task. For example, device 114 may trigger devices 104 and 106 to engage security protocols according to a predetermined policy. In some implementations, the device 114 may trigger such devices to engage security measures without having a policy in place for such measures.

In some implementations, selecting the at least two devices includes configuring the at least two devices to communicate to execute a plurality of separate portions of the task. For example, the device 114 may configure device 104 and device 106 to communicate via Bluetooth, for example, in order to engage and disengage the security measures in a specific order. For example, if the door lock device 104 is unlocked, the security device 106 may then be turned off.

In some implementations, selecting the at least two devices includes determining which of the plurality of devices include components configured to execute the two or more capabilities to complete the task and configuring the at least two devices to communicate to complete the task. For example, the device 114 may trigger synchronization of security measures between device 104 and device 106.

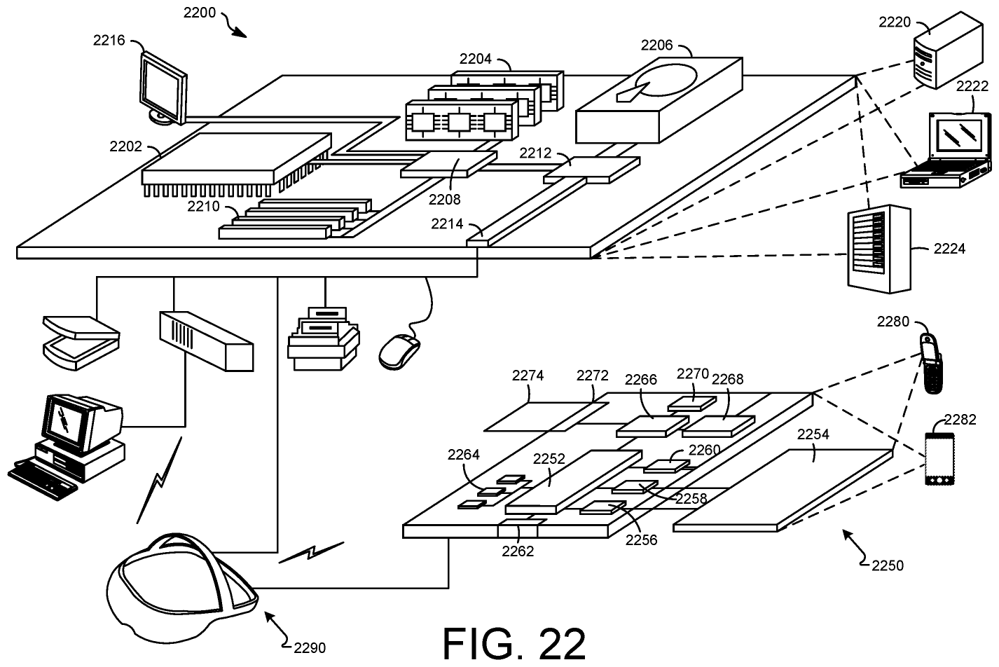

FIG. 22 shows an example of a computer device 2200 and a mobile computer device 2250, which may be used with the techniques described here. Computing device 2200 is intended to represent various forms of digital computers, such as laptops, desktops, tablets, workstations, personal digital assistants, smart devices, appliances, electronic sensor-based devices, televisions, servers, blade servers, mainframes, and other appropriate computing devices. Computing device 2250 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 2200 includes a processor 2202, memory 2204, a storage device 2206, a high-speed interface 2208 connecting to memory 2204 and high-speed expansion ports 2210, and a low speed interface 2212 connecting to low speed bus 2214 and storage device 2206. The processor 2202 can be a semiconductor-based processor. The memory 2204 can be a semiconductor-based memory. Each of the components 2202, 2204, 2206, 2208, 2210, and 2212, are interconnected using various busses, and may be mounted on a common motherboard or in other manners as appropriate. The processor 2202 can process instructions for execution within the computing device 2200, including instructions stored in the memory 2204 or on the storage device 2206 to display graphical information for a GUI on an external input/output device, such as display 2216 coupled to high speed interface 2208. In other implementations, multiple processors and/or multiple buses may be used, as appropriate, along with multiple memories and types of memory. Also, multiple computing devices 2200 may be connected, with each device providing portions of the necessary operations (e.g., as a server bank, a group of blade servers, or a multi-processor system).

The memory 2204 stores information within the computing device 2200. In one implementation, the memory 2204 is a volatile memory unit or units. In another implementation, the memory 2204 is a non-volatile memory unit or units. The memory 2204 may also be another form of computer-readable medium, such as a magnetic or optical disk. In general, the computer-readable medium may be a non-transitory computer-readable medium.

The storage device 2206 is capable of providing mass storage for the computing device 2200. In one implementation, the storage device 2206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods and/or computer-implemented methods, such as those described above. The information carrier is a computer- or machine-readable medium, such as the memory 2204, the storage device 2206, or memory on processor 2202.

The high speed controller 2208 manages bandwidth-intensive operations for the computing device 2200, while the low speed controller 2212 manages lower bandwidth-intensive operations. Such allocation of functions is exemplary only. In one implementation, the high-speed controller 2208 is coupled to memory 2204, display 2216 (e.g., through a graphics processor or accelerator), and to high-speed expansion ports 2210, which may accept various expansion cards (not shown). In the implementation, low-speed controller 2212 is coupled to storage device 2206 and low-speed expansion port 2214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 2200 may be implemented in a number of different forms, as shown in the figure. For example, it may be implemented as a standard server 2220, or multiple times in a group of such servers. It may also be implemented as part of a rack server system 2224. In addition, it may be implemented in a personal computer such as a laptop computer 2222. Alternatively, components from computing device 2200 may be combined with other components in a mobile device (not shown), such as device 2250. Each of such devices may contain one or more of computing device 2200, 2250, and an entire system may be made up of multiple computing devices 2200, 2250 communicating with each other.

Computing device 2250 includes a processor 2252, memory 2264, an input/output device such as a display 2254, a communication interface 2266, and a transceiver 2268, among other components. The device 2250 may also be provided with a storage device, such as a microdrive or other device, to provide additional storage. Each of the components 2250, 2252, 2264, 2254, 2266, and 2268, are interconnected using various buses, and several of the components may be mounted on a common motherboard or in other manners as appropriate.

The processor 2252 can execute instructions within the computing device 2250, including instructions stored in the memory 2264. The processor may be implemented as a chipset of chips that include separate and multiple analog and digital processors. The processor may provide, for example, for coordination of the other components of the device 2250, such as control of user interfaces, applications run by device 2250, and wireless communication by device 2250.

Processor 2252 may communicate with a user through control interface 2258 and display interface 2256 coupled to a display 2254. The display 2254 may be, for example, a TFT LCD (Thin-Film-Transistor Liquid Crystal Display) or an OLED (Organic Light Emitting Diode) display, or other appropriate display technology. The display interface 2256 may comprise appropriate circuitry for driving the display 2254 to present graphical and other information to a user. The control interface 2258 may receive commands from a user and convert them for submission to the processor 2252. In addition, an external interface 2262 may be provide in communication with processor 2252, so as to enable near area communication of device 2250 with other devices. External interface 2262 may provide, for example, for wired communication in some implementations, or for wireless communication in other implementations, and multiple interfaces may also be used.

The memory 2264 stores information within the computing device 2250. The memory 2264 can be implemented as one or more of a computer-readable medium or media, a volatile memory unit or units, or a non-volatile memory unit or units. Expansion memory 2274 may also be provided and connected to device 2250 through expansion interface 2272, which may include, for example, a SIMM (Single In Line Memory Module) card interface. Such expansion memory 2274 may provide extra storage space for device 2250, or may also store applications or other information for device 2250. Specifically, expansion memory 2274 may include instructions to carry out or supplement the processes described above, and may include secure information also. Thus, for example, expansion memory 2274 may be provide as a security module for device 2250, and may be programmed with instructions that permit secure use of device 2250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 2264, expansion memory 2274, or memory on processor 2252, that may be received, for example, over transceiver 2268 or external interface 2262.

Device 2250 may communicate wirelessly through communication interface 2266, which may include digital signal processing circuitry where necessary. Communication interface 2266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 2268. In addition, short-range communication may occur, such as using a Bluetooth, Wi-Fi, or other such transceiver (not shown). In addition, GPS (Global Positioning System) receiver module 2270 may provide additional navigation- and location-related wireless data to device 2250, which may be used as appropriate by applications running on device 2250.

Device 2250 may also communicate audibly using audio codec 2260, which may receive spoken information from a user and convert it to usable digital information. Audio codec 2260 may likewise generate audible sound for a user, such as through a speaker, e.g., in a handset of device 2250. Such sound may include sound from voice telephone calls, may include recorded sound (e.g., voice messages, music files, etc.) and may also include sound generated by applications operating on device 2250.

The computing device 2250 may be implemented in a number of different forms, as shown in the figure. For example, it may be implemented as a cellular telephone 2280. It may also be implemented as part of a smart phone 2282, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as modules, programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor, or LED (light emitting diode)) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user is provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A computer-implemented method, the method comprising:
detecting, by a computing device, a plurality of additional devices associated with a user environment;
determining, for the plurality of additional devices, a plurality of capabilities associated with the plurality of additional devices;
configuring, by the computing device, the plurality of additional devices as a distributed computing system, the plurality of additional devices corresponding to at least one of the plurality of capabilities and a device location within the user environment;
receiving, at the computing device, a request to execute a task;
determining, by the computing device, which of the plurality of additional devices are capable of executing the task;
selecting at least one of the plurality of additional devices determined to be capable of executing the task, the selecting based at least on:
a determined proximity of the plurality of additional devices to the computing device or a user associated with the request to execute the task,
a determined operating system executing on a respective device in the plurality of additional devices, and
at least one determined sensor-based capability available on a respective device in the plurality of additional devices; and
triggering, by the computing device, the selected at least one of the plurality of devices to execute the task.

2. The computer-implemented method of claim 1, wherein selecting of the at least one of the plurality of additional devices is further based on detected information associated with the user environment, the user environment defined as a physical building containing the computing device and the plurality of additional devices.

3. The computer-implemented method of claim 2, wherein the detected information corresponds to a detected user activity level in the user environment, a detected audio request in the user environment, or detected visual imagery associated with the user environment.

4. The computer-implemented method of claim 1, further comprising:
selecting, by the computing device, a second device in the plurality of additional devices to generate output corresponding to the task, the selection of the second device based at least on determining that the selected at least one of the plurality of additional devices is unsuited to generate and communicate output corresponding to the task.

5. The computer-implemented method of claim 1, further comprising:
selecting, by the computing device, a second device of the plurality of additional devices to generate output corresponding to the task, the selection of the second device based at least on determining that the location of the at least one of the plurality of additional devices is out of a predefined visual range or predefined audio range of the user associated with the request to execute the task.

6. The computer-implemented method of claim 1, wherein triggering the selected device to execute the task includes generating visual and audio output, the visual and audio output provided on another of the plurality of additional devices in response to determining a time of day outside of a predefined time period.

7. The computer-implemented method of claim 1, wherein triggering, by the computing device, the selected device to execute the task includes accessing, via an operating system associated with the computing device, at least one service in communication with the respective operating system executing on the selected at least one additional device, the service configured to dispatch the received task to at least one other device in the plurality of additional devices.

8. The computer-implemented method of claim 1, wherein selecting the at least one of the plurality of additional devices to execute the task includes:
determining a context for the user environment, the context based on detected information and stored information associated with the at least one of the plurality of additional devices.

9. The computer-implemented method of claim 8, wherein the detected information includes calendar information.

10. A computer program product tangibly embodied on a non-transitory computer-readable medium and comprising instructions that, when executed, are configured to cause at least one processor to:
detect, by a computing device, a plurality of additional devices associated with a user environment;
determine, for the plurality of additional devices, a plurality of capabilities associated with each of the respective additional devices;
configure, by the computing device, the plurality of additional devices as a distributed computing system, the plurality of additional devices corresponding to at least one of the plurality of capabilities and a device location within the user environment;
receive, at the computing device, a request to execute a task; and
in response to determining that completing execution of the task indicates the use of two or more of the plurality of capabilities:
determine, within the distributed computing system, which of the plurality of additional devices is capable of executing the task;
select at least two devices, in the plurality of additional devices, to share execution of the two or more capabilities to complete the task, the selecting of the at least two devices based at least on a determined proximity of the two devices to the computing device or to a user associated with the request to execute the task; and
trigger, by the computing device, the selected at least two devices to execute the task.

11. The computer program product of claim 10, wherein selecting the at least two devices includes configuring the at least two devices to communicate to execute a plurality of separate portions of the task.

12. The computer program product of claim 10, wherein selecting the at least two devices includes:
determining which of the plurality of devices include components configured to execute the two or more capabilities to complete the task;
configuring the at least two devices to communicate to complete the task.

13. The computer program product of claim 10, wherein at least one capability associated with at least one of the two devices extends a capability associated with the other of the at least two devices.

14. The computer program product of claim 10, wherein the execution of the task is triggered in the absence of Internet connectivity for the devices in the distributed computing system.

15. A system comprising:
a display;
memory; and
at least one processor coupled to the memory, the at least one processor being configured to:
detect, by a computing device, a plurality of additional devices associated with a user environment;
determine, for the plurality of additional devices, a plurality of capabilities associated with the at least one of the plurality of additional devices;
configure, by the computing device, the plurality of additional devices as a distributed computing system, the plurality of additional devices corresponding to at least one of the plurality of capabilities and a device location within the user environment;
receive, at the computing device, a request to execute a task;
determine, by the computing device, which of the plurality of additional devices are capable of executing the task;
select at least one of the plurality of additional devices determined to be capable of executing the task, the selecting being based at least on a determined proximity of the plurality of devices to the computing device or to a user associated with the request to execute the task; and
trigger, by the computing device, the selected at least one of the plurality of devices to execute the task.

16. The system of claim 15, wherein configuring the plurality of additional devices as a distributed computing system includes:
enabling, for the plurality of additional devices, policies and user preferences associated with the user environment and the computing device; and
in response to detecting an unidentified device within the user environment, performing a security check on the unidentified device, and configuring the policies and user preferences on the unidentified device if the unidentified device passes the security check.

17. The system of claim 15, further comprising displaying a graphical control element on the display of the computing device to enable user selected control for the device selected to execute the task.

18. The system of claim 15, further comprising:
selecting, by the computing device, a second device of the plurality of additional devices to generate output corresponding to the task, the selection of the second device based at least on determining that the location of the at least one of the plurality of additional devices is out of a predefined visual range or predefined audio range of a user associated with the request to execute the task.

19. The system of claim 15, wherein triggering the selected device to execute the task includes generating visual output, the visual output provided on the display of the computing device, in response to determining that the computing device is within a threshold distance to a user associated with the received request to execute the task.

20. The system of claim 15, wherein triggering, by the computing device, the selected device to execute the task includes accessing, via an operating system associated with the computing device, at least one service in communication with the selected at least one additional device, the service configured to dispatch the received task to at least one other device in the plurality of additional devices.
